(19) United States
(12) Patent Application Publication
(10) Pub. No.: US 2013/0196053 A1
(43) Pub. Date: Aug. 1, 2013

(54) FLOW CELL DESIGN FOR UNIFORM RESIDENCE TIME FLUID FLOW

(71) Applicant: State of Oregon acting by and through the State Board of Higher Education on behalf of Oregon State Univ, Corvallis, OR (US)

(72) Inventors: Brian K. Paul, Corvallis, OR (US); Clayton L. Hires, Beaverton, OR (US); Chih-hung Chang, Corvallis, OR (US)

(73) Assignee: State of Oregon acting by and through the State Board of Higher Education on behalf of Oregon Stat, Corvallis, OR (US)

(21) Appl. No.: 13/738,896

(22) Filed: Jan. 10, 2013

Related U.S. Application Data
(60) Provisional application No. 61/650,367, filed on May 22, 2012.
(60) Provisional application No. 61/585,199, filed on Jan. 10, 2012.

(51) Int. Cl. B05C 3/02

(52) U.S. Cl. CPC B05C 3/02
USPC 427/58; 118/429; 118/58; 118/428

(57) ABSTRACT

Embodiments of a deposition reactor that compensates for lateral flow variation are disclosed. The reactor has at least one wall defining a deposition chamber comprising a first region and a second region, the wall having a purposely formed curvature defining a height of the deposition chamber. An inlet for a fluid comprising reactants or deposition material is in fluid communication with the deposition chamber. Portions of the fluid flowing through the deposition chamber have a residence time within the deposition chamber that varies by ≦20% across a cross-sectional width of the deposition chamber. The deposition chamber may further comprise an outlet in fluid communication with a third region. The reactor is suitable for depositing material layers having a uniform thickness. Methods of using the reactor also are disclosed.

### CROSS-REFERENCE TO RELATED APPLICATIONS

This claims the benefit of U.S. Provisional Patent Application No. 61/650,367, filed May 22, 2012, and U.S. Provisional Patent Application No. 61/585,199, filed Jan. 10, 2012, each of which is incorporated in its entirety herein by reference.

### ACKNOWLEDGMENT OF GOVERNMENT SUPPORT

This invention was made with government support under Prime Award No. DE-AC05-76RL01830 awarded by U.S. Department of Energy/Sub Award No. 57494-79791 awarded by Pacific Northwest National Laboratory. The government has certain rights in this invention.

### FIELD

The present disclosure concerns a deposition reactor device for material layer deposition, which compensates for lateral flow variation across a single, high-aspect ratio flow cell, and methods of using the device for depositing material layers, generally as thin films, on substrates.

### PARTIES TO JOINT RESEARCH AGREEMENT

The State of Oregon, acting by and through the State Board of Higher Education on behalf of Oregon State University, and Battelle Memorial Institute, Pacific Northwest Division, manager and operator of Pacific Northwest National Laboratory, owned by the United States Department of Energy, are parties to a joint research agreement related to the technology disclosed herein.

### BACKGROUND

Cadmium sulfide (CdS) is often used to form the core buffer layer component of a heterojunction photovoltaic (PV) cell. One step in production of thin film CdTe and CuJnSe₂ solar cells is the deposition of CdS as a thin film to serve as a “buffer layer” between the optically absorbent layer and the transparent conducting oxide (TCO) layer to complete an effective p-n junction. As a buffer layer, CdS reduces reflection in the absorption layer of the cell and extends the distance electrons can travel before recombination can occur. Methods for CdS deposition include vapor phase techniques such as physical and chemical vapor phase deposition (PVD, CVD) and liquid phase processes such as chemical bath deposition (CBD), electrochemical deposition and successive ionic layer adsorption reactions. When considering these methods, CBD typically is valued as the industry standard due to its relative ease to implement, low temperature (<100° C.), atmospheric pressures, and low expense for covering large surface area devices.

The typical CBD process utilizes a large volume of reaction fluid that is not in intimate contact with the substrate surface. This leads to an extremely high volume-to-surface area ratio. This arrangement provides conditions for spatially uniform film growth rates across the substrate area, but also results in low yields of cadmium conversion to the final film due to precipitation of CdS in the bulk solution. This leads to poor material utilization and excess waste solvent generation. Conventional CBD also has the problem of allowing unwanted precipitates and by-products to settle on the desired film, interrupting the coherency of the film. Additionally, the reagent concentrations decrease over time in a static bath, causing the reaction conditions and growth rate to vary in a temporal manner.

Operating under microreactor conditions can improve yield and decrease waste solvent production in comparison to typical CBD reactor conditions (McPeak et al., Crystal Growth and Design; Vol. 9; 2009 p. 4538-4545). This occurs due to the greatly reduced diffusion times experienced in sub-millimeter length channels. However, a distinct parabolic growth rate pattern can sometimes be seen as fluid travels faster down the axial center regions in comparison to the outer edges of the reactor.

### SUMMARY

Embodiments of a device for controlling flow variations in a deposition chamber are disclosed. Embodiments of methods for using the deposition device also are disclosed.

The deposition device includes at least one wall defining a top portion and two side portions of a deposition chamber having a width in the x-axis, a length in the y-axis, and a height in the z-axis, the deposition chamber having a first region and a second region. The deposition chamber has an inlet in fluid communication with the first region. The at least one wall has a purposely formed curvature in the xz-plane or both the xz- and yz-planes. The purposely formed curvature defines the deposition chamber height, and alters fluid flow characteristics in the deposition chamber. In some embodiments, the wall further has a curvature in the xy-plane that defines the deposition chamber width.

In certain embodiments, the deposition device further includes a doctor blade substantially parallel to and adjacent to a distal end of the second region. In some embodiments, the deposition chamber further includes a third region, and an outlet in fluid communication with the third region.

In some embodiments, the purposely formed curvature in the top portion is selected to provide a substantially constant flow velocity, a substantially constant residence time through a length of the deposition chamber, or a combination thereof, for portions of a fluid flowing across a cross-sectional width of the second region.

The purposely formed curvature in the xz-plane may produce a minimum height along a central lengthwise axis of the deposition chamber. In certain embodiments, the curvature defines a substantially continuous convex curve into the deposition chamber across a width of the deposition chamber. In some embodiments, the purposely formed curvature varies in the yz plane along a central lengthwise axis of the deposition chamber such that the deposition chamber has a height at a distal portion of the deposition chamber that is greater than a height adjacent to the inlet. The purposely formed curvature may be adjustable, i.e., the curvature magnitude and/or profile in the xz-plane, the yz-plane, or both the xz- and yz-planes may be varied.

Portions of a fluid flowing through a deposition chamber may have a variable residence time within the deposition chamber. In one embodiment, the residence time varies by ≦20% across a cross-sectional width of the deposition chamber. A fluid flowing through a deposition chamber may produce a moving front, wherein the moving front may have a variable position as measured from the inlet. In one embodiment, the moving front has a position that has a standard deviation of ≦20% across a cross-sectional width of the deposition chamber as the fluid flows through the second region.

In some embodiments, each of the two side portions extends outwardly from a central lengthwise axis of the deposition chamber for a first distance L1 to form the first region, and extends over a second distance L2 to form the second region. Each of the side portions may define an arc segment over a second distance L2 to form the second region, wherein each arc segment has an arc length to arc height ratio of ≧5. When the deposition chamber includes the third region, each of the two side portions further extends inwardly over a third distance L3 to form the third region. In one embodiment, L1 and L3 each independently extend 5% to 40% of the deposition chamber length. L3 may be greater than L1.

In some examples, the top portion of the at least one wall is pre-formed, (e.g., deflected, machined, molded) to have the purposely formed curvature. In certain embodiments, the top portion may be dynamically deflected. The top portion may include deflecting means capable of deflecting the top portion in the xz-plane, the yz-plane, or both the xz- and yz-planes to produce the curvature. For example, the top portion may further comprise a flexible component defining an upper surface of the deposition chamber and a rigid component positioned above the flexible component. In one embodiment, the top portion may be deflected by including one or more set screws extending downwardly through the rigid component such that a lower end of at least one set screw contacts an upper surface of the flexible component and applies a downward force to the flexible component, thereby producing the second curvature. In one embodiment, the one or more set screws are adjustable to produce a desired curvature magnitude, curvature profile, or a combination thereof.

The deposition chamber may have a maximum width to maximum height ratio of at least 50. In some embodiments, the deposition chamber has a maximum width of 50 mm to 1,500 mm, a minimum height of at least 0.1 mm, and a maximum height less than or equal to 10 mm. The deposition chamber may have a sufficient length and a sufficient width for depositing a thin film having a surface area of up to 20,000 cm².

The deposition device may further include at least one unit operation device, such as a mixer in fluid communication with the inlet, a substrate heater, a deposition chamber heater, or a pre-heater positioned upstream of the inlet.

The deposition device may further include a substrate. The substrate may be positioned on a bottom portion of the at least one wall. In certain embodiments, the at least one wall defines a top portion and two side portions of the deposition chamber, and the substrate defines a bottom portion of the deposition chamber. In some embodiments, the deposition device includes a heating device to heat the substrate to a desired temperature. The substrate may be movable relative to the at least one wall.

The purposely formed curvature enables a solution flowing through the deposition chamber to deposit a material layer onto the substrate, and preferably to deposit a material layer having a substantially uniform thickness onto the substrate. For example, the material layer may have an average thickness, such as an average thickness ≦50 nm, and a thickness standard deviation that is less than 15% of the average thickness.

At least two disclosed devices may be placed either in series or in parallel for depositing at least one material layer, and potentially two or more material layers, onto a substrate.

In certain embodiments, the deposition device is positioned onto a movable substrate before flowing a solution through the deposition chamber, wherein the substrate forms a bottom portion of the deposition chamber, and the substrate is moved relative to the deposition device to form a material layer on the substrate. In one embodiment, the substrate may be moved substantially continuously in a direction concurrent with, or countercurrent to, the direction of solution flow through the deposition chamber.

In another embodiment, the deposition device is positioned onto a first portion of a substrate before flowing a solution through the deposition chamber, wherein the substrate forms a bottom portion of the deposition chamber. The solution is flowed through the deposition chamber from the inlet to the outlet for a period of time to form a material layer on the first portion of the substrate. The deposition device then is removed from the first portion of the substrate, and positioned onto a subsequent portion of the substrate. The solution then is flowed again through the deposition chamber from the inlet to the outlet for a period of time to form a material layer on the subsequent portion of the substrate.

The foregoing and other objects, features, and advantages of the invention will become more apparent from the following detailed description, which proceeds with reference to the accompanying figures.

### BRIEF DESCRIPTION OF THE DRAWINGS

The patent or application file contains at least one drawing executed in color. Copies of this patent with color drawings will be provided by the Patent and Trademark Office upon request and payment of the necessary fee.

FIG. 1 is a streamline profile graph illustrating computer-simulated streamline pathways generated by releasing and tracing a point particle from the flow cell inlet (half model shown).

FIG. 2 is a diagram illustrating an exemplary curvature profile for equivalent velocities or residence time within each individual channel of a flow cell.

FIG. 3 is a series of diagrams a-c illustrating moving front progressions for baseline parallel plates at 800 μm depth.

FIG. 4 is a graph illustrating the standard deviations of moving fronts for baseline parallel plates at 800 μm depth. (Shows half plane at center axis.)

FIG. 5 is a diagram illustrating channel heights determined by computational flow dynamics (CFD) compared to channel heights experimentally measured using a laser scanning microscope; the percentage error also is shown for each data point.

FIG. 6 is a series of diagrams a-c illustrating moving front progressions for one embodiment of an FEA (fixed element analysis) deflected model (200 μm).

FIG. 7 is a graph illustrating the standard deviation of the moving front for baseline parallel plates at 800 μm depth. (Shows half plane at center axis.)

FIG. 8 is a top plan view diagram of one embodiment of a solution deposition reactor.

FIG. 9 is a top plan view diagram of another embodiment of a solution deposition reactor.

FIG. 10 is a series of photographs illustrating the results of a dye test for visual distribution in flow cells with parallel channels (left) and an FEA model at 200 μm deflection (right) conducted with one embodiment of a solution deposition reactor.

FIG. 11 is a diagram illustrating one embodiment of thermocouple and deflection screw positions for the flow cell shown in FIG. 8.

FIG. 12 is a cross-sectional view of one embodiment of a solution deposition reactor with a preformed, downwardly curved top plate.

FIG. 13 is a schematic diagram of one embodiment of an interdigital micromixer.

FIG. 14 is a schematic diagram of one embodiment of a flow-field mixer.

FIG. 15 is a diagram of a plurality of MASD reactors.

FIG. 16 is a schematic diagram illustrating one embodiment of a method for depositing a material layer onto a substrate using a solution deposition reactor.

FIG. 17 is an exploded solidworks model illustrating the components used to form one embodiment of a flow cell.

FIG. 18A is a cross-sectional view along the y-axis of the flow cell of FIG. 17.

FIG. 18B is a cross-sectional view along the x-axis of the flow cell of FIG. 17.

FIG. 19 is a schematic diagram illustrating one embodiment of a system including a solution deposition reactor.

FIG. 20 is transmission electron microscopy image of a cross-sectioned CdS film between a fluorine-doped tin oxide layer and a carbon film.

FIG. 21 is a graph of physical thickness measured by transmission electron microscopy versus optical thickness measured by the relationship between film thickness and percent transmission at 500 nm for CdS films produced using deposition times ranging from 1 minute to 15 minutes.

FIG. 22 is a photograph illustrating a labeling system for measuring film thickness points of a final deflected film.

FIGS. 23A-23D illustrate the thickness profiles for CdS films produced using one embodiment of a flow cell with a parallel plate (FIGS. 23A, 23B) and a deflected plate (FIGS. 23C, 23D).

FIG. 24 shows grazing-incidence X-ray diffractograms of a bare fluorinated tin oxide substrate (FTO) and a CdS film deposited onto the FTO substrate (CdS/FTO) by one embodiment of a deflected-plate flow cell.

### DETAILED DESCRIPTION

Embodiments of a continuous-flow, solution deposition reactor are disclosed. Under continuous flow conditions, intermediate chemistries (e.g., reaction intermediates) can be used advantageously, by-products and precipitates can be swept through the deposition chamber, and/or reaction conditions can be kept substantially constant with respect to time. Embodiments of the disclosed solution deposition reactor compensate for lateral flow variation across a single, high-aspect ratio flow cell. The cross-sectional area of the flow cell's deposition chamber is manipulated to compensate for the variation in travel length for streamlines of each pathway (e.g., axial center regions and outer edges) through the deposition chamber. In some embodiments, the amount of flow resistance near the axial center region of the flow cell is increased by curving the upper surface downward into the deposition chamber, thus reducing the channel height in that region. Embodiments of the disclosed solution deposition reactor are suitable for constant-flow deposition of thin films utilized in a broad array of applications. For example, the disclosed solution deposition reactors are suitable for low-temperature, constant-flow deposition of thin films, such as thin films utilized in photovoltaic cells, batteries, and heat exchangers.

In some embodiments, the solution deposition reactor is a microreactor-assisted-solution-deposition reactor, which combines microreactor technology with continuous flow deposition. Certain embodiments of the disclosed solution deposition reactor are suitable for large-scale (e.g., 60 cm×60 cm) solution deposition of thin films having a uniform thickness. The solution deposition reactor may have a length and width suitable for depositing a thin film having a surface area of up to 20,000 cm². The film may have an average thickness and a thickness standard deviation that is less than 10% of the average thickness. In a working embodiment, a 152×152 mm deflected-plate, solution deposition reactor for CdS deposition increased film thickness uniformity by more than 5-fold compared to other continuous flow-deposited thin films. A final film thickness of 21.5 nm±2.6 nm was achieved.

### I. REACTOR MODELING

A microscale flow chamber with several parallel rectangular channels was characterized by Pan et al. (Chemical Engineering Journal 137; 2008, p. 339-346) in which an electrical network parody was used to describe the fluidic system. Operating under laminar conditions, the Hagen-Poiseuille Equation can be used to relate flow conditions within each microchannel.

$$Hagen \text{-} Poiseuille Equation \text{:} Δ P = \frac{32 μ L {λ}_{NC}}{{D}_{H}^{2}} U = \frac{32 μ L {λ}_{NC}}{{D}_{H}^{2} A} Q \qquad ( Eq . 1 )$$

ΔP is pressure drop across the channel, L is channel length, D_{H} is hydraulic diameter, A is channel cross-sectional area, Q is volumetric flow rate, μ is dynamic viscosity, and λ_{NC} is correction factor for non-circular channels.

Pan et al. translated each term in the Hagen-Poiseuille equation to match variables in the Ohm's law equation: V=IR (Eq. 2). Voltage potential, V, is considered equivalent to pressure potential, current, I, is equivalent to volumetric flow rate, and electrical resistance, R, is equivalent to the remaining terms in Hagen-Poiseuille equation to represent the fluid flow resistance:

$$R = \frac{32 μ L {λ}_{NC}}{{D}_{H}^{2} A} \qquad ( Eq . 3 )$$

Pan et al. then modeled the channels within their flow chamber as a complex system of resistances arranged in series and parallel then applied the “junction rule” and “loop rule” to solve for unknown terms in their system. Using this method the focus of their work was to solve for optimal dimensions of their inlet and outlet manifolds to minimize variation in flow distribution between each micro-channel.

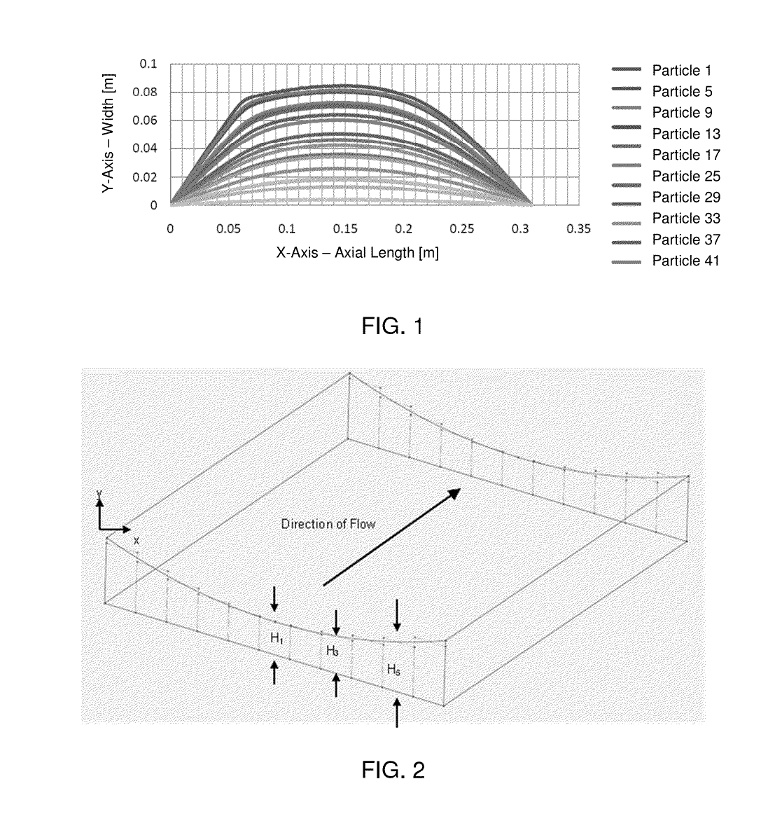

A similar approach can be used to design a single, high-aspect ratio channel (e.g., 0.8 mm×152 mm) without individual interior micro-channels. The assumption is made that a single wide aspect ratio channel can be represented by a collection of imaginary parallel channels that share equivalent inlet and outlet endpoints. The pathway and length of each of these imaginary channels is determined through streamlines generated by tracer particles using computational fluid simulations shown in FIG. 1. This is explained in further detail in the Computational Fluid Simulation section.

Applying the Hagen-Poiseuille Equation and using the boundary conditions of equivalent ΔP and equivalent velocities within each channel, the relationship between channels reduces to a ratio of their hydraulic diameter and pathway length.

$$\begin{matrix}{V}_{1} = {V}_{2} = {V}_{3} = … & ( Eq . 4 ) \\ \frac{{D}_{{H}_{1}}^{2}}{{L}_{1}} = \frac{{D}_{{H}_{2}}^{2}}{{L}_{2}} = \frac{{D}_{{H}_{3}}^{2}}{{L}_{3}} = … & ( Eq . 5 )\end{matrix}$$

Using channel lengths represented in FIG. 1, hydraulic diameters were calculated for each streamline which can be further represented by the width, W, and height, I-I of each individual “microchannel.” To simplify the analysis, each “channel” was assumed to have a constant submillimeter width, which was varied. The effect of resultant deflection profiles on flow front development across the deposition region was performed using computational fluid dynamics (CFD) simulations. Using channel lengths generated from the streamline graph and the arbitrary widths of 0.5 mm, 0.25 mm, and 0.1 mm the remaining variable of height, H, is solved resulting in a row of channels with unique heights needed to maintain equivalent velocity in each channel. A line is then fitted to the midpoint of the top surface in each channel to define a continuous upper surface downwardly curved profile in the deposition region of the flow cell (FIG. 2).

It is expected that as the width used for each channel decreases, the number of channels used to construct the flow chamber will increase. Accordingly, the model response will approach that of a continuous open chamber without separate channels.

In some embodiments, the flow cell geometry comprises an area with diverging sides before the front plane and an area of converging edges after the ending plane. In such embodiments, fluid is expected to travel at a constant rate in the substrate area but enter this area at different times due to the different lengths traveled in the diverging/converging regions. As an alternative model to setting the velocity equivalent in each channel, the boundary condition of equivalent residence time in each channel is also considered for comparison. This is expected to allow the fluid velocity in each channel to compensate for the different lengths traveled in diverging and converging regions.

### II. COMPUTATIONAL FLUID DYNAMICS SIMULATIONS

Parallel plate and deflected plate flow cell geometries were constructed in SolidWorks 2010. The baseline case to which all deflected plate results were compared was the condition of two perfectly parallel plates set 800 μm apart. The flow chamber geometry was then imported to FLUENT (Fluent, Inc.) and three-dimensional CFD (computation fluid dynamics) analyses were used to investigate the deflection-modified geometry. Two-dimensional triangular meshes were generated on the base surface, and channel depth was partitioned into 10 segments resulting in 1,763,700 total elements. The boundary conditions for the simulation included no-slip conditions at the flow cell walls and atmospheric pressure at the outlet. Water with a density and viscosity of 9.98×10² kg/m³ and 1 cP, respectively, was used as the fluid. An inlet velocity of 0.089 m/s was calculated from an inlet area of 5.85 mm² and volumetric flow of 31.1 mL/min. Laminar conditions were confirmed at the inlet with an Re of 1,211, which is lower than the 2,000 threshold for this assumption.

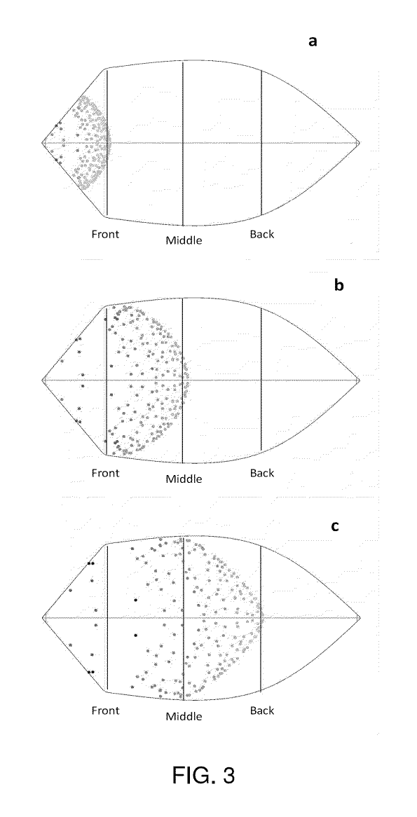

The flow cell uniformity was evaluated by tracking the flow front across the flow cell. FLUENT was used to simulate the pulse injection of 100 point particles and track their positions over progressive time intervals. Evaluation of uniformity was done by monitoring the position of these particles along the front edge of the pulse injection as seen in FIG. 3.

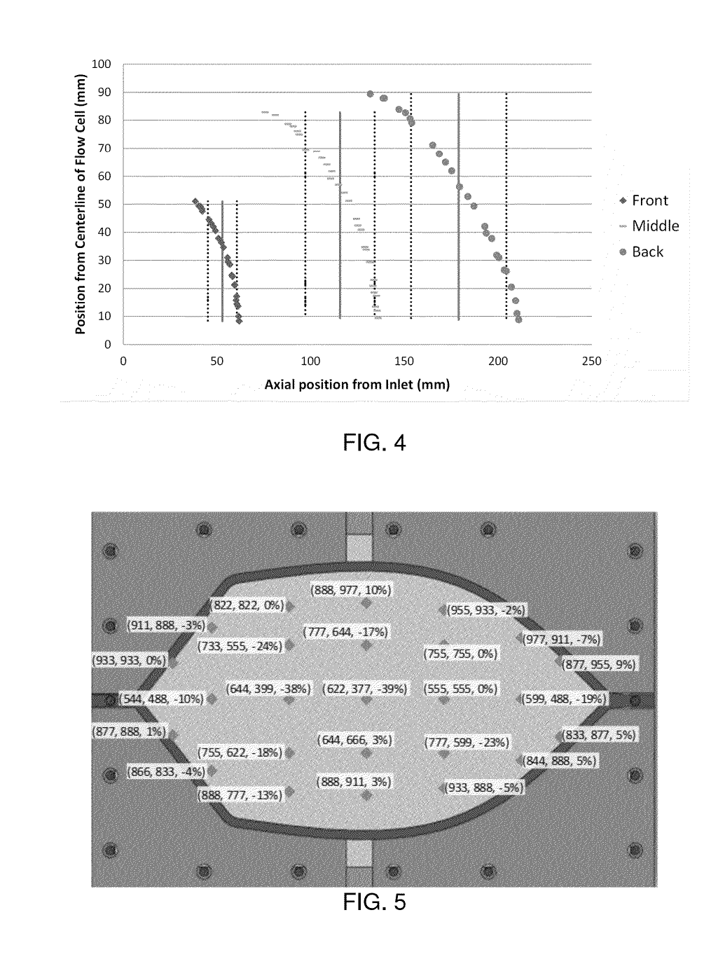

The coefficient of variation of the flow front was evaluated by dividing the standard deviation of the flow front into the average progression along the length of the flow cell specifically as it passed the front, middle and back planes of the substrate. As shown in FIG. 4, a distinctive parabolic profile results along the front edge of the particles in the parallel plate flow cell. The parabolic profile becomes progressively more pronounced with time. This indicates that fluid flow is much faster as it moves closer to the axial center flow path. In the embodiment illustrated in FIG. 4, the standard deviation for the flow front increased from 7.7 mm to 25.5 mm from the front plane to the back plane.

Several curved plate profiles were produced for evaluation. Constant velocity profiles were produced by assuming that the heights for each streamline were constant along the flow path. The loft feature in Solidworks, which creates a feature by making transitions between profiles, was used between each streamline to construct the upper surface of the flow chamber, creating an initial downwardly curved surface. The flow chamber geometry was then imported to Fluent and evaluated as a three-dimensional CFD analysis under conditions specified above.

Additional curved plate profiles were constructed using finite element analysis (Cosmos) to simulate the method to be used to create the upper curved plate in the physical experiment. As discussed below in Example 1, the flow cell was fitted with a pattern of set screws that could individually place point loads to deflect the plates at different places on the flow cell. The goal of the finite element analyses was to determine the pattern of point forces needed to closely match constant velocity profiles. For FEA, material properties of the flow cell were input into the Cosmos model and forces were applied at point positions along the central axis and elsewhere until profiles nearing the best constant velocity profile were attained. Exact force magnitudes were not considered important outcomes of the model as point force calibration would be difficult. Rather, this model was used to predict the type of deflected profile that could readily be attained with a specific set screw pattern. The distorted geometry resulting from these point forces was then imported into Fluent and evaluated for effect on flow profile. FIG. 5 is a diagram of one embodiment of a flow cell having an upper plate that is downwardly curved in the xz-plane. Channel heights determined by computational flow dynamics (CFD) are compared to channel heights experimentally measured using a laser scanning microscope. The percentage error also is shown for each data point. The flow cell had a height of 800 μm along the edges and a centerline height of about 600 μm, providing roughly 200 μm of deflection along the centerline.

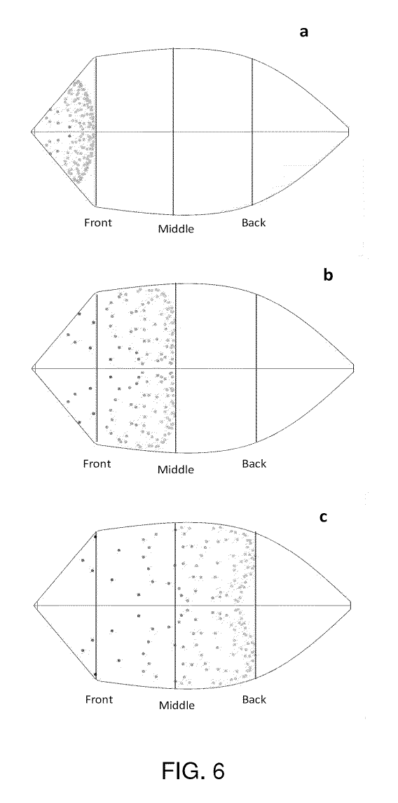

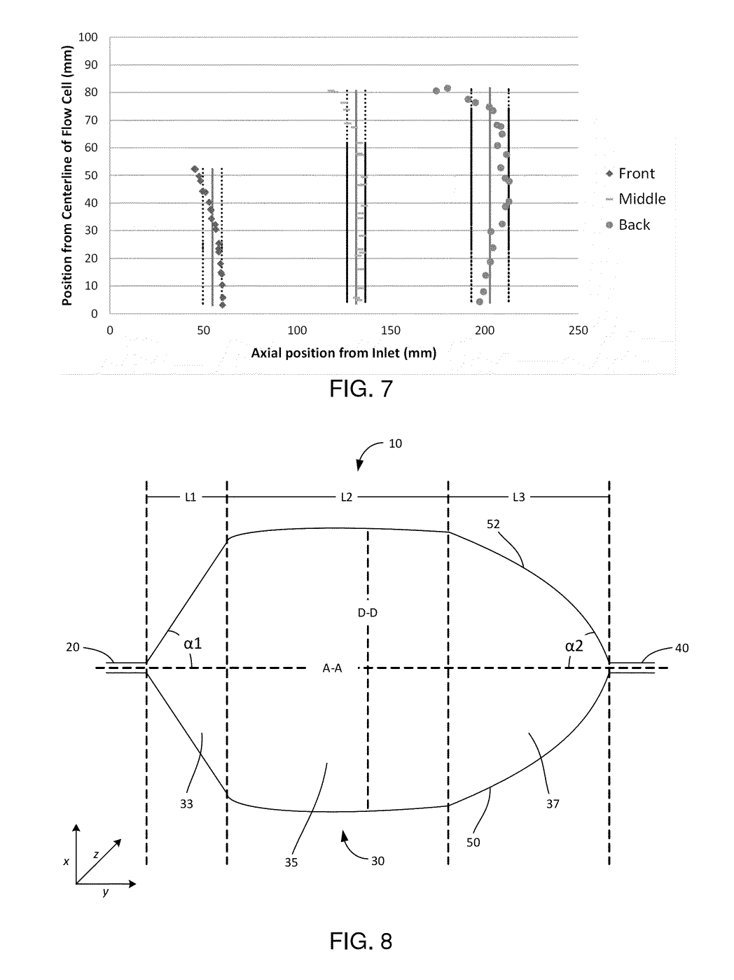

The simulated flow front response for this curved profile is shown in FIGS. 6 and 7. The standard deviations were 5.00 mm in the front plane, 4.9 mm in the middle plane, and 10.0 mm in the back plane. The curved plate profile was expected to greatly reduce the flow front profile over the substrate.

### III. SOLUTION DEPOSITION REACTORS

Disclosed embodiments of a solution deposition reactor include at least one wall, which defines a deposition chamber that includes a first region and a second region, and an inlet in fluid communication with the first region. In some embodiments, the deposition chamber further includes a third region, and an outlet in fluid communication with the third region.

The deposition chamber has a length (y-axis), a width (x-axis) that may vary along the y-axis, and a height (z-axis) that varies in the xy-plane. The at least one wall defines a top portion and two side portions of the deposition chamber. In other words, the wall may be a unitary piece shaped to define the top portion and the side portions. The unitary wall further may define a bottom portion of the deposition chamber. In some examples, the deposition chamber has a top wall, side walls and, optionally, a bottom wall. If present, the bottom portion, or bottom wall, typically is planar.

The top portion, or top wall, has a purposely formed curvature in the xz-plane defining the deposition chamber height at any given point along the x-axis. The top portion may also have a purposely formed curvature in the yz-plane defining the deposition chamber height at any given point along the y-axis. In some embodiments, the side portions, or side walls, have a curvature in the xy-plane to define the deposition chamber width at any point along the x-axis.

The side portions and top portion together define the flow path within the deposition chamber. The top portion curvature(s) and, if present, the side portion curvature alter fluid flow characteristics in the chamber. For example, the curvature(s) may be selected to provide a substantially constant flow rate and/or a substantially constant residence time across the deposition chamber's width. From a viewpoint within the deposition chamber, the top portion curvature is convex in the xz-plane and/or the yz-plane, and the side portion curvature (if present) is concave in the xy-plane.

In some embodiments, the curvature magnitude in the xz-plane reaches a downward maximum along the central, lengthwise axis of the deposition chamber, producing a height in the center of the deposition chamber's width that is less than the height lateral to the center. The curvature in the xz-plane may be a parabolic curve.

If the top portion has a curvature in the yz-plane, the curvature magnitude may increase along the deposition chamber length, producing a first chamber height at a first distance along the deposition chamber length and a second chamber height at a second distance along the deposition chamber length, wherein the second chamber height is greater than the first chamber height. This height increase along the chamber length increases the instantaneous residence time as reactants flow from front to back of the deposition chamber to compensate for reductions in reactant concentrations and reaction rates as reactants become depleted while a material layer is deposited.

In some embodiments, the solution deposition reactor side portions, or side walls, are curved, wherein each curved side wall (a) extends outward from a central lengthwise axis of the deposition chamber for a first distance to form the first region, and (b) defines an arc segment over a second distance to form the second region. In certain embodiments, each curved wall then extends inward toward an outlet over a third distance to form a third region.

Embodiments of the disclosed solution deposition reactors provide balanced reagent concentration and residence time within the deposition chamber, thereby avoiding or minimizing reactant depletion effects, and providing a deposited material layer having a substantially uniform thickness throughout its breadth and length. Assuming uniform reagent concentrations within the flow, control over film thickness uniformity depends at least in part upon having a uniform velocity profile across the breadth of the deposition region. Because reagent concentrations may not remain uniform throughout the deposition chamber length (due to, for example, reactant depletion), the velocity profile may be managed, in part, by varying the chamber height along the chamber length. The velocity profile not only affects reagent residence time across and along the deposition region, but also affects the thickness of the fluid boundary layer through which reactants diffuse.

As shown in a top plan view in FIG. 8, one embodiment of a solution deposition reactor 10 has an inlet 20, a deposition chamber 30, and an outlet 40. Disclosed embodiments of the solution deposition reactor have a high aspect ratio, i.e., the ratio of the deposition chamber maximum width (x-axis) to the deposition chamber maximum height (z-axis). For example, the solution deposition reactor may have an aspect ratio of at least 50 at least 100, at least 150, at least 175, or at least 200, such as 50 to 700, 100 to 600, or 175 to 600. In one embodiment, a solution deposition reactor has dimensions of 150 mm width×0.8 mm height, thereby providing an aspect ratio of 187.5. In another embodiment, a solution deposition reactor may have dimensions of 600 mm×1 mm, providing an aspect ratio of 600.

In some embodiments, the inlet 20 and outlet 40 have a narrow diameter, e.g., ≦20 mm, such as 1 to 20 mm, 1 mm to 10 mm, 1 mm to 5 mm, 5 mm to 20 mm, or 5 mm to 15 mm. Desirably the inlet and outlet diameters are selected to have a sufficient diameter to provide adequate flow through the flow cell without being so large as to allow the reactants to reside within the inlet for sufficient time to form particles, such as nanoparticles, within the inlet rather than forming on the substrate within the flow cell. The deposition chamber 30 is defined by a top plate or wall (not shown), an optional bottom plate or wall (not shown), and side walls 50, 52. In some embodiments, the bottom plate is a substrate for material layer deposition. In other embodiments, a substrate, such as an aluminum, glass, polymer, or silicon substrate, is placed on top of the bottom plate. A surface of the substrate may include no prior material layers, or may include one or more material layers (e.g., coatings and/or thin-films), and the solution deposition reactor may be utilized to deposit an additional material layer onto the substrate. For example, the substrate may be a fluorinated tin oxide-coated glass substrate, or a substrate upon which a copper indium gallium selenide (CIGS) layer has been deposited.

The deposition chamber 30 has a varying diameter, or width, defined by side walls 50, 52, which describe three regions of the deposition chamber: a first region 33, a second region 35, and a third region 37. A person of ordinary skill in the art will understand that the dimensions of the deposition chamber can vary. For example, large-scale depositions will utilize a deposition chamber with greater volume, such as a reactor chamber with a larger diameter. In certain embodiments, the side walls 50, 52 define a deposition chamber 30 having a width that varies from ≦100 mm, such as ≦20 mm, adjacent to the inlet 20 and outlet 40 to a maximum width of up to 1,500 mm, such as up 1000 mm, or up to 600 mm, throughout the second region 35 of the deposition chamber 30. In some embodiments, the maximum width is at least 1 mm, at least 10 mm, at least 50 mm, at least 100 mm, 1-1,500 mm, 10-1,500 mm, 10-1,000 mm, or 10-600 mm.

In one embodiment, as shown in FIG. 8, each of side walls 50, 52 extends outward from a lengthwise central axis A-A of the deposition chamber 30 for a first distance L1 from the inlet 20, defines an arc segment over a second distance L2, and then extends inward over a third distance L3 to the outlet 40. In some embodiments, the arc segment defined by each of side walls 50, 52 has an arc length to arc height ratio of ≧5, such as ≧10, ≧20, ≧25, ≧50, or ≧100. In some embodiments, the arc segments defined by side walls 50, 52 have the same arc length to arc height ratio. In another embodiment, the side walls 50, 52 diverge outward at a first angle, α1, from the inlet over a distance L1, remain parallel, substantially parallel, or otherwise define an arc segment throughout the length L2 of the mid portion of the deposition chamber, and then converge inward at a second angle, α2, over a third distance L3 toward the outlet. When α1 and α2 are 7-8°, minimum drag is produced in first region 33 and third region 37. However, such an acute angle may result in a flow cell having an undesirable length for L1 and/or L3. It is advantageous to minimize L1 and L3 so that L2 can be maximized. Thus, α1 and α2 typically are less acute than 7-8°. For example, α1 and α2 may be 20-60°, such as 30-50°. The first and second angles, α1 and α2, may be the same or different. Including a curvature, or arc, over the second distance L2 also may reduce drag, or flow resistance, along side walls 50, 52. Depending on the desired reaction and/or the desired size of the thin film, the deposition chamber 30 may have a length of 100-10,000 mm, such as 100-5,000 mm, 100-1,000 mm, 100-500 mm, or 200-300 mm. In some embodiments, L1 and L3 independently extend 5% to 40% of the deposition chamber length, such as 20% to 30% of the deposition chamber length. In certain examples, L1 and L3 are minimized. L1 and L3 may be determined, at least in part, by the substrate diameter. For example, as the substrate diameter increases, L1 and/or L3 may increase to provide a desired α1 or α2, respectively. L2 is determined, at least in part, by the substrate size, e.g., by the maximum width or diameter D-D. In some embodiments, L2 is 2-3× the substrate diameter. For instance, when a substrate's width is one meter, L2 may be 2-3 meters.

In some embodiments, the volume area of first region 33 (and distance L1) is minimized to reduce dead volume prior to deposition in second region 35. In certain embodiments, back pressure in third region 37 is reduced or minimized by reducing the angle of convergence a over distance L3, thereby increasing L3, such that side walls 52, 54 gradually converge toward outlet 40. Thus, third region 37 is typically larger than first region 33, and L3 >L1.

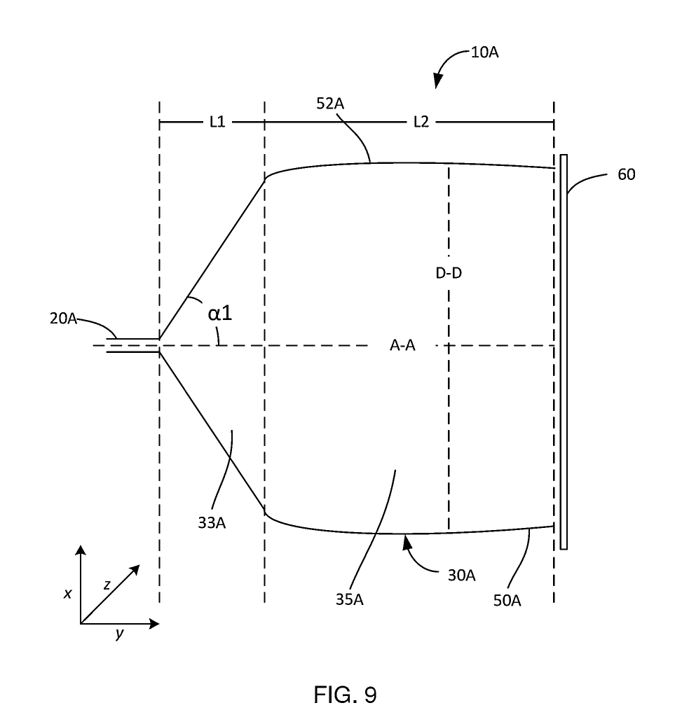

FIG. 9 illustrates another embodiment of a solution deposition reactor 10A. Solution deposition reactor 10A includes an inlet 20A and a deposition chamber 30A. Deposition chamber 30A is defined by a top plate or wall (not shown), a bottom plate or substrate (not shown), and side walls 50A, 52A. Deposition chamber 30A includes a first region 33A and a second region 35A. Solution deposition reactor 10A is suitable for use with a continuously, or substantially continuously, moving substrate. In certain embodiments, the solution deposition reactor and the substrate are capable of relative movement. For example, the substrate may be moved in a linear manner relative to the deposition chamber's y-axis. In one embodiment, the substrate movement is concurrent with the flow through deposition chamber 30A. In another embodiment, the substrate movement is countercurrent to the flow through deposition chamber 30A. Excess solution exits solution deposition reactor 10A at the distal end of second region 35A, and may be collected, e.g., in a storage vessel such as a tank.

In one embodiment, a doctor blade 60 is positioned substantially parallel to and adjacent to the distal end of second region 35A as shown in FIG. 9. Doctor blade 60 may be constructed of any material compatible with the solution flowing through solution deposition reactor 10A, e.g., an inert metal, plastic, silicone, etc. A lower edge of doctor blade 60 is positioned at a height substantially corresponding to an upper surface of the material layer deposited onto the substrate. Doctor blade 60 removes excess solution exiting solution deposition reactor 10A. In another embodiment (not shown), doctor blades may be placed adjacent to each side wall 50A, 52A.

The deposition chamber has a height defined by the distance between the top portion and the bottom portion, e.g., between a top wall or plate and a bottom wall or plate. In some embodiments, the deposition chamber has a height ranging from 0.1 mm to 100 mm, such as 0.1 mm to 50 mm, 0.1 mm to 25 mm, 0.1 mm to 10 mm 0.1 mm to 8 mm, 0.1 mm to 5 mm, 0.1 mm to 2 mm, 0.1 mm to 1 mm, 0.5 mm to 10 mm, 0.5 mm to 5 mm, 0.5 mm to 1 mm, 1 mm to 10 mm, 1 mm to 5 mm, 2 mm to 10 mm, or 2 mm to 5 mm.

One or both of the top and bottom walls may be purposely curved, or may be dynamically deflectable, to form a purposely curved wall and provide a variable cross-sectional profile of the distance between the top and bottom walls. Thus, the height may vary within the deposition chamber. In some embodiments, the height varies in the xz-plane across the width of the deposition chamber, in the yz-plane along the length of the deposition chamber, or both. The deposition chamber may have a minimum height from 0.1 mm to 2 mm, such as from 0.2 mm to 1 mm, or from 0.5 mm to 5 mm. When the deposition chamber has a purposely curved top and/or bottom wall, the deposition chamber has a maximum height that is greater than the minimum height. For example, the maximum height may be from 0.2 mm to 10 mm, such as from 0.5 mm to 5 mm, or from 1 mm to 10 mm.

In some examples, the height varies in the xz-plane across the deposition chamber's width, typically with a minimum height along the deposition chamber's central, lengthwise axis, and a maximum height adjacent to the side walls. A top wall curvature, such as a parabolic curvature, in the xz-plane compensates for the effect of drag adjacent the side walls, which slows down the rate of fluid flow near the sides relative to the rate of fluid flow along a central lengthwise axis of the deposition chamber. As discussed in more detail below, the height variance is selected to provide a substantially even moving front as a reactant solution flows through the deposition chamber.

The height also may vary in the yz-plane along the deposition chamber's length. For example, the height may increase from the inlet to the outlet, or distal portion of the deposition chamber. As a solution flows through the deposition chamber, the concentration of reactants within the solution may decrease, for example, as reactants combine and are deposited as a material layer (e.g., a thin film) onto the substrate. Thus, the material layer's thickness may decrease along the deposition chamber's length as the reactant concentrations decrease. Increasing the height of the chamber as the solution flows toward the outlet decreases the solution flow rate, thereby increasing the residence time in the distal portion of the deposition chamber to provide sufficient time for the reactants to combine and deposit onto the distal portion of the substrate. The height variance along the deposition chamber length provides a more uniform material layer thickness along the substrate length.

Hence, in certain examples, the height varies across the deposition chamber's width and across the deposition chamber's length. In particular, the height along the central lengthwise axis increases from the inlet to the outlet, and the height across the deposition chamber's width has a minimum along the central lengthwise axis and a maximum adjacent to the side walls.

In some embodiments, the bottom wall, or substrate, is substantially planar. However, the top wall is non-planar, and is curved or dynamically deflectable to provide a variable cross-sectional profile. The top wall has a purposely formed downward curve towards the bottom wall in the xz-plane (see, e.g., FIG. 2), thereby providing a lower height in the axial center regions in comparison to the outer edges of the reactor chamber. The maximum downward curve, or deflection, is greater than 0% to 99.5% of the height, such as from 1% to 95%, 1% to 90%, 5% to 80%, 5% to 50%, 10% to 80%, 20% to 90%, 20% to 50%, 50%-99%, or 75-99.5%. As the substrate width increases, the degree of curvature in the xz-plane typically increases. Thus, a large substrate, such as a substrate having a width of 600-1,000 mm, may have a maximum height along the deposition chamber side walls of several millimeters and a minimum height along the deposition chamber's lengthwise central axis of less than 1 mm, producing a maximum downward curvature, or deflection, in the xz-plane of up to 99.5% of the maximum height. In particular working embodiments, a deposition chamber, with a maximum width of 150 mm, had a maximum height adjacent to its side walls of 800 μm with a downward, continuously variable, curvature of its upper wall, reaching a maximum downward curvature, or deflection, of 200-400 μm along the central lengthwise axis to provide a minimum deposition chamber height of 400 μm to 600 μm along the central lengthwise axis (see e.g., FIG. 2). In another example, a deposition chamber may have a maximum height adjacent to its side walls of 1.6 mm and a minimum deposition chamber height of 800 μm along the central lengthwise axis.

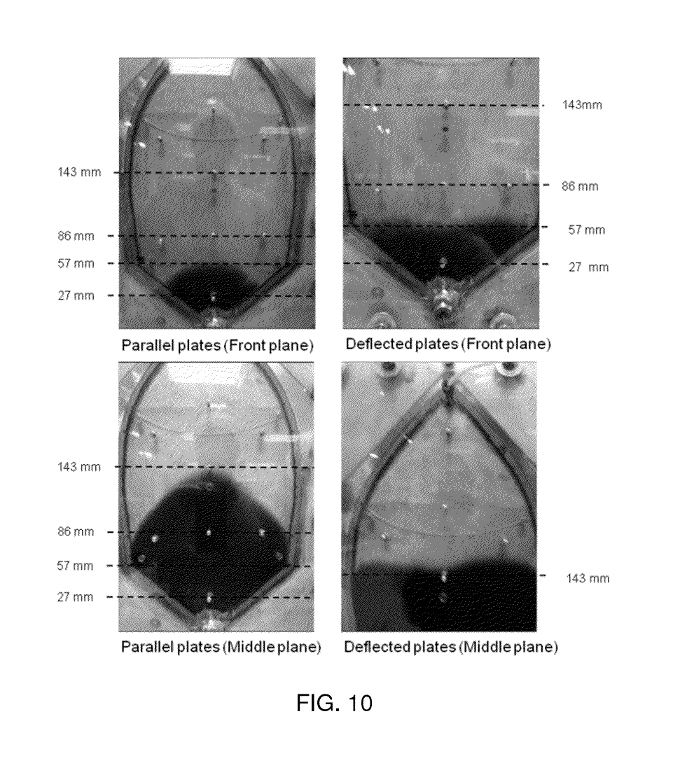

The magnitude and profile of the curvature in the xz-plane is selected to, inter alia, provide a substantially constant flow rate across the deposition chamber width as a fluid flows through the deposition chamber. As shown in FIG. 10 and further discussed in Example 2, a reactor with substantially parallel upper and bottom plates produced a parabolic moving front that became progressively more pronounced as a fluid flowed through the deposition chamber. In contrast, a reactor with a 200-μm downward curvature, or deflection, in its top plate (non-deflected height=800 μm) produced a substantially even moving front as the dye solution flowed through the deposition chamber.

Thus, the top wall curvature in the xz-plane is selected to minimize the non-linearity of the moving front as the fluid flows through the middle portion, L2, of the deposition chamber. A substantially linear moving front facilitates deposition of thin films having a uniform thickness. In some examples, the purposely formed curvature of the top wall in the xz-plane produces a moving front having a position that has a standard deviation of ≦20%, such as ≦15%, ≦10%, or ≦5%, across a cross-sectional width of the deposition chamber as the fluid flows over the distance L2. In certain embodiments, (e.g., FIG. 6), a fluid flowing through the deposition chamber produces a substantially even, or linear, moving front.

Desirably, variations in residence time for portions of a fluid flowing through the deposition chamber are minimized to facilitate uniform reaction conditions and deposition of a thin film with uniform thickness throughout its length and width. In some embodiments, portions of a fluid flowing through the deposition chamber from the inlet to the outlet have a substantially constant residence time within the deposition chamber. In some embodiments, the residence time varies by ≦20%, such as ≦15%, ≦10%, or ≦5%, across a cross-sectional width of the deposition chamber. In other words, a portion of the fluid flowing proximal to the side wall has substantially the same residence time within the deposition chamber as a portion of the fluid flowing along the central lengthwise axis of the deposition chamber.

Embodiments of the disclosed solution deposition reactors are capable of depositing material layers having a desired average thickness. Certain exemplary embodiments are capable of depositing material layers having an average thickness of ≦50 nm, such as ≦40 nm, ≦30 nm, ≦25 nm, 10 nm to 50 nm, 20 nm to 45 nm, or even 15 nm to 25 nm. The material layers may have a thickness standard deviation that is less than 20% of the average thickness, less than 15% of the average thickness, or even less than 10% of the average thickness.

In some embodiments, the solution deposition reactor is a “static” device with a purposely formed, fixed downward curvature in the xz-plane and/or yz-plane, as defined by at least one surface curved towards a second surface, e.g., a lower surface of a top wall curved downward towards an upper surface of a bottom wall. In other embodiments, the solution deposition reactor is a “dynamic” device with an adjustable downward curvature in the xz-plane and/or yz-plane.

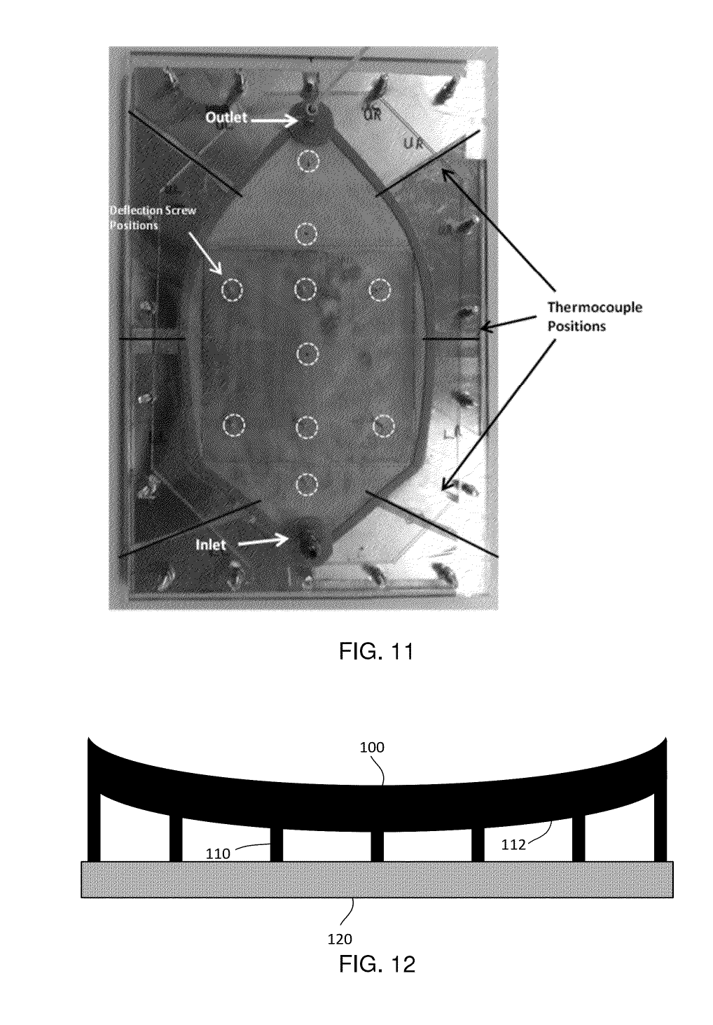

A dynamic solution deposition reactor may have a top portion that includes deflecting means capable of deflecting the top portion to produce the second curvature. The deflecting means can be any suitable means capable of imparting a downward force to the top portion. In one embodiment, a dynamic solution deposition reactor has the structure shown in FIG. 11. A downward deflection results from a plurality of set screws, which apply point pressures to the top plate, or wall. For example, as illustrated in FIG. 11, a plurality of set screws or posts may be positioned along the central lengthwise axis of the deposition chamber. Additional set screws or posts may be placed outwardly from the central lengthwise axis in the widest portion of the deposition chamber. The deflection magnitude is determined by the magnitude of the pressure applied to the top wall by the set screws. Each set screw may be adjusted to increase or decrease deflection of the top wall in the vicinity of where the set screw contacts the top wall. A person of ordinary skill in the art will understand that other deflection means can be used, such as an inflatable bladder, or pneumatic or hydraulic mechanisms.

In one embodiment, set screws may be inserted through the top plate with the screw tips pressing upon or embedded in the deposition chamber bottom wall. The deflection magnitude is determined by the length(s) of the screws or posts and/or the proportion(s) of the screws or posts that penetrates into the bottom wall.

A person of ordinary skill in the art understands that, in certain embodiments, it is desirable to avoid protrusions that extend into the deposition chamber. The protrusions may disrupt fluid flow through the deposition chamber and/or produce discontinuities in the deposited film. Thus, in some embodiments, deflection is performed by applying pressure to the top wall, wherein the pressure varies along the x-axis and/or y-axis to produce a downward curvature in the xz-plane and/or yz-plane.

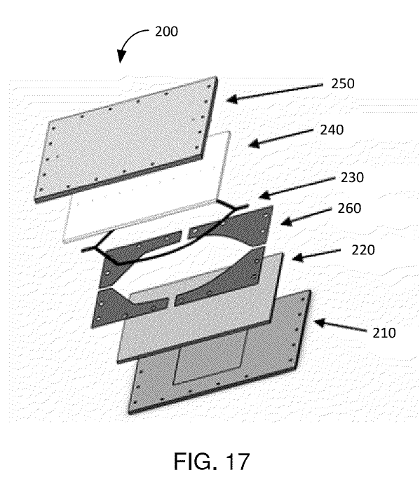

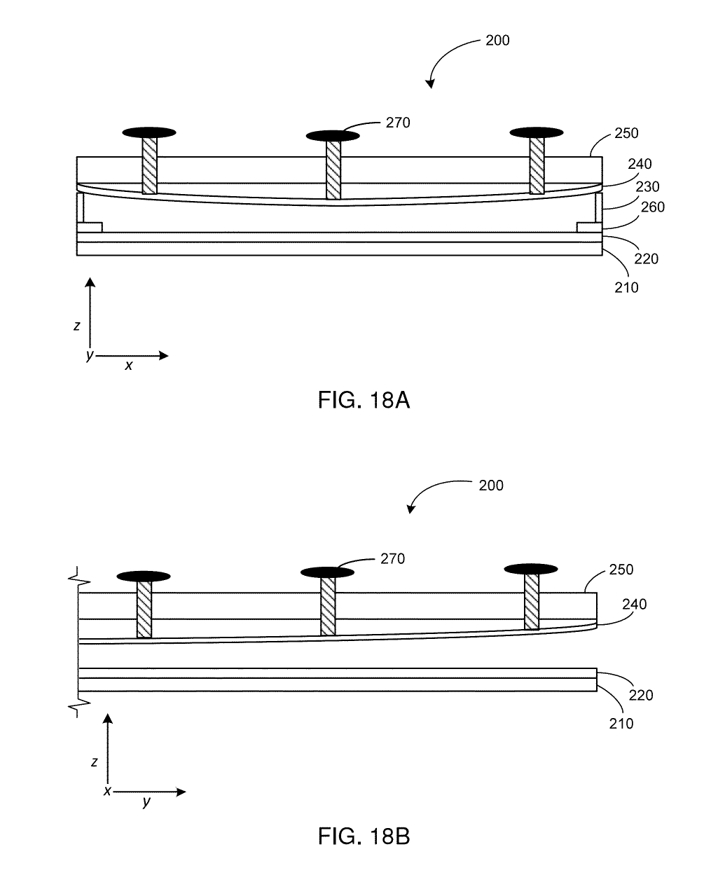

An exemplary dynamic solution deposition reactor 200 is shown in an exploded view in FIG. 17. FIG. 18A is a cross-sectional view of solution deposition reactor 200 along the y-axis. FIG. 18B is a cross-sectional view of solution deposition reactor 200 looking along the x-axis. Reactor 200 includes a bottom plate 210 and a substrate 220 placed on bottom plate 210. Deposition chamber side walls are defined by a gasket 230, such as a compressible, closed-cell silicone foam gasket. Rigid shims 260 may be included to maintain a minimum deposition chamber height. An upper surface of the deposition chamber is defined by a flexible top sheet 240, e.g., a flexible polycarbonate sheet, with inlet and outlet ports. A rigid top plate 250 with complementary inlet and outlet ports is placed over top sheet 240, thereby forming a two-layered top wall. Set screws, or posts, 270 are inserted through top wall 250 and are adjusted to exert pressure on flexible top sheet 240, thereby producing a purposely formed desired downward deflection of top sheet 240. Advantageously, the screws/posts are adjustable by any suitable means, including manual adjustment, or automatic adjustment, such as pneumatic adjustment, hydraulic adjustment, adjustment using solenoids, etc. Adjusting the screws/posts allows a user to select a desired downward curvature in the xz-plane (FIG. 18A), the yz-plane (FIG. 18B), or both the xz- and yz-planes. By adjusting the pressure applied, the user can produce a desired curvature magnitude, curvature profile (i.e., shape), or both.

In another embodiment, an inflatable bladder (not shown) may be placed between flexible top sheet 240 and rigid top plate 250. Inflating the bladder exerts downward pressure on top sheet 240, deflecting it downwardly into the deposition chamber. The size and/or shape of the bladder, as well as the amount of inflation, can be varied to produce a desired downward curvature.

A static solution deposition reactor may have a top wall with a preformed downward curvature in the xz-plane and/or the yz-plane, typically with a maximum curvature in the xz-plane occurring along the reactor's central lengthwise axis. For example, the top wall may be constructed from a thermally deformable plastic that may be deflected when heated above a particular temperature, and will retain the curvature when cooled. In one embodiment, a top wall (e.g., a metal, polymer, or ceramic wall) may be machined to achieve a curved lower surface. In another embodiment, the curvature may be embossed, molded, imprinted, or stamped into a top wall formed from a suitable material, such as a polymer, glass, metal, or ceramic material. In one embodiment, the solution deposition side walls provide the desired spacing between the top wall and the bottom wall. In another embodiment, as shown in FIG. 12, the top plate 100 may further comprise a plurality of preformed posts, or projections, 110 extending downward from a lower surface 112 of the top wall. Posts 110 provide contact with, and maintain a desired separation from, the bottom wall 120. As the size of the solution deposition reactor, and its diameter, increases, the embodiment shown in FIG. 12 may facilitate maintaining an exact height between the top and bottom walls.

In some embodiments, the solution deposition reactor further includes additional unit operation devices, such as a mixer, a heater (e.g., a substrate heater, a deposition chamber heater, and/or a pre-heater positioned upstream of the inlet). For example, the solution deposition reactor may include a mixer in fluid communication with inlet 20. The mixer effectively mixes fluids to initiate formation of the deposition material. In some embodiments, the mixer facilitates formation of intermediate chemistries that may not otherwise be obtainable with premixed reagents.

In certain embodiments, the mixer is a micromixer, such as an interdigital micromixer. Micromixers offer features that cannot be easily achieved using macroscopic devices, such as ultrafast mixing on the microscale (D. Bokenkamp, A. Desai, X. Yang, Y.-C. Tai, E. M. Marzluff, S. L. Mayo., Anal. Chem., 1998, 70, 232). Two fluids to be mixed are introduced into the mixer, often as two counter-flowing fluid streams. For an interdigital micromixer, the two fluids enter interdigital channels (30 μm in a working embodiment) and form plural interpenetrated substreams. The substreams exit the interdigital channels perpendicular to the direction of the feed flows, initially with a multilayered structure. Fast mixing through diffusion soon follows due to the small thickness of individual layers.

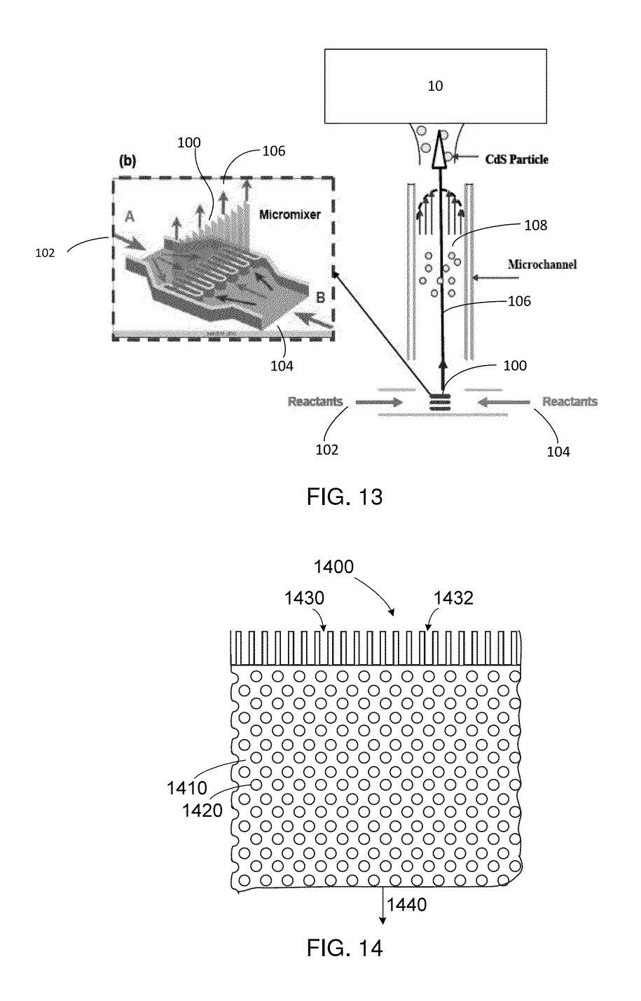

One embodiment of an interdigital micromixer 100 is shown in FIG. 13. FIG. 13 shows that a first reactant stream 102 and a second reactant stream 104 flow into micromixer 100, thereby forming a third stream 106 comprising the desired chemical species for substrate deposition. Third stream 106 flows through a channel 108, particularly a microchannel, and into inlet 20 of solution deposition reactor 10.

In another embodiment, the mixer is a flow-field mixer. A first reactant stream and a second reactant stream flow into a mixer comprising a flow field. The mixed reactant streams then flow into the inlet or a solution deposition reactor. A flow field may be generally formed by a pair of opposed walls that define an outer periphery of the flow field. A space is positioned between the walls and fluid flows within the space from an inlet toward an outlet. One or more discrete support structures, such as wall segments, are positioned in the space between the walls. The support structures may be arranged in a variety of spatial arrangements relative to one another. For example, the support structures may be arranged in a regular array or in a random distribution. The support structures may have a variety of shapes and sizes and may be in the form of pins, wall segments, bumps, protrusions, etc. The support structures differ from elongated walls or dividers that form microchannels in that the support structures do not define discrete, elongated flow pathways. Rather, a plurality of the support structures are positioned in the general flow space between the opposed walls without specifically guiding the fluid in a particular direction. A partial schematic diagram of an exemplary flow field mixer 1400 is shown in FIG. 14. A flow field 1410 is created by a plurality of support structures 1420. A first reactant stream 1430 and a second reactant stream 1432 flow into the flow field 1410. As the reactant streams 1430, 1432 flow around the support structures 1420, mixing occurs. A mixed stream 1440 then exits the flow field and flows into the inlet of the solution deposition chamber.

In some embodiments, the solution deposition reactor is placed upon a substrate that is movable relative to the solution deposition reactor. For example, the solution deposition reactor may be maintained in a fixed position, and the substrate may be placed upon, e.g., a conveyor, which moves the substrate relative to a lengthwise axis of the solution deposition reactor. In one embodiment, the substrate is moved in a direction concurrent with the fluid flow through the solution deposition reactor. In another embodiment, the substrate is moved countercurrent to the fluid flow through the solution deposition reactor.

In some examples, two or more substrates are placed upon a conveyor. A first substrate is positioned beneath the solution deposition reactor, thereby forming a bottom portion of the reactor. A solution is flowed through the solution deposition reactor for a period of time sufficient to deposit a material layer upon the substrate. The solution deposition reactor is then lifted from the substrate, and the conveyor is activated to move a subsequent substrate into position beneath the solution deposition reactor for solution deposition.

In one embodiment, a plurality of solution deposition reactors is positioned in series relative to the substrates on the conveyor. A first solution deposition reactor deposits a first material layer onto a substrate. The first solution deposition reactor is then lifted from the substrate, and the conveyor is activated to move the substrate into position beneath a subsequent solution deposition reactor. The subsequent solution deposition reactor then deposits a subsequent material layer onto the first material layer, thereby producing a multilayered composition upon the substrate. The first and subsequent material layers may have the same or different material compositions.

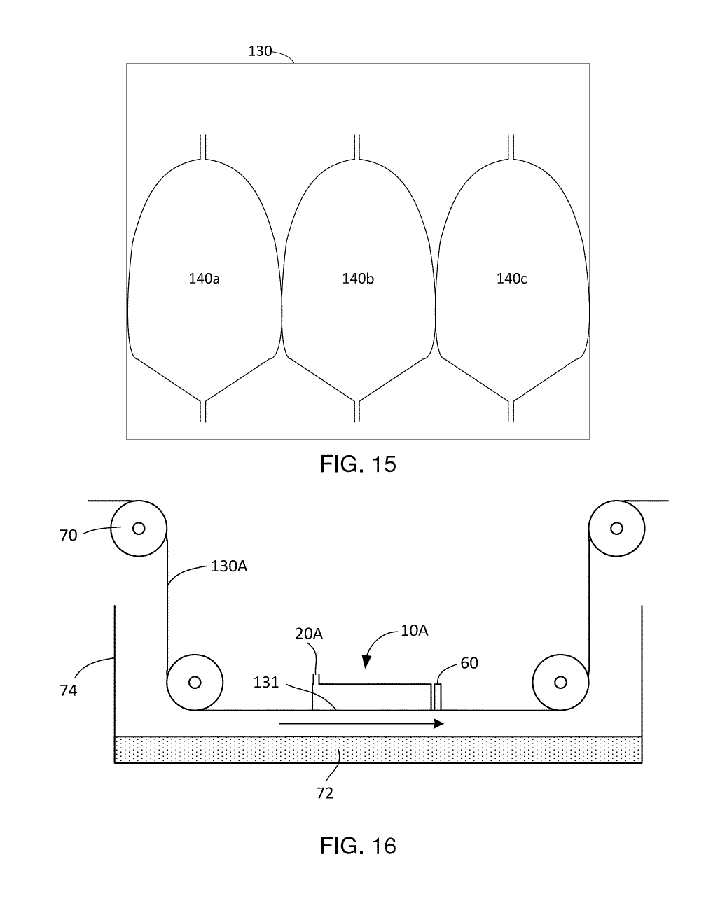

As shown in FIG. 15, a movable substrate 130 may have a width greater than a width of a solution deposition reactor. In such embodiments, a plurality of solution deposition reactors 140a, 140b, 140c may be placed in parallel across the substrate 130. Desirably, each of the plurality of solution deposition reactors 140a, 140b, 140c is placed in close proximity to the adjacent solution deposition reactor(s), thereby depositing a substantially continuous material layer across substrate 130 as the substrate is moved in a direction concurrent to, or countercurrent to, the fluid flow through the solution deposition reactors.

In another embodiment, a substrate may have a length that is greater than a length of a solution deposition reactor, and a plurality of solution deposition reactors may be placed in series along the length of the substrate. The solution flowing through each solution deposition reactor may have the same chemical composition, or the chemical compositions may be different. The substrate may be stationary, and a plurality of thin films may be deposited in series along the length of the substrate.

Depositing a uniform material layer onto a movable substrate can be difficult. Commonly encountered problems include solvent evaporation, particularly at elevated temperatures, spilling of solution over the substrate's sides, and/or a meniscus effect across the width of the substrate, resulting in a film that is thicker or thinner at its edges. Solvent evaporation may further cause deposition, or trapping, of waste materials or undesirable byproducts in the material layer. Some embodiments of the disclosed solution deposition reactors solve these problems, and also may reduce material waste. In one embodiment, illustrated in FIG. 16, a solution deposition reactor 10A deposits a material layer onto a movable substrate 130A in a continuous or substantially continuous process. A series of rollers 70 moves substrate 130A in a continuous or substantially continuous manner in the direction of the arrow. Solution deposition reactor 10A is lowered into position to contact an upper surface 131 of substrate 130A. A solution comprising one or more reactants flows into solution deposition reactor 10A through inlet 20A. As the solution flows through solution deposition reactor 10A, a material layer is deposited onto upper surface 131 of substrate 130A. Concurrent movement of substrate 130A helps “pull” the solution through solution deposition reactor 10A. Desirably, the solution flow rate through solution deposition reactor 10A is adjusted such that the solution flows at a faster rate than substrate 130A is moving. If the flow rate is equal to the substrate rate of movement, reactants in the solution may be depleted before reaching the distal end of solution deposition reactor 10A. A faster flow rate ensures replenishment of reactants, and facilitates formation of a uniform material layer on substrate 130A. A faster flow rate also may facilitate mass transport of waste, or byproducts, out of the solution deposition reactor. The effects of reactant depletion also can be ameliorated by having a curvature in the yz-plane of the solution deposition reactor top wall such that the reactor has a greater height at its distal end compared to the height adjacent to the inlet. Excess solution exiting the distal end of solution deposition reactor 10A is wiped from substrate 130A by doctor blade 60. Excess solution 72 is collected in a storage tank 74 positioned beneath substrate 130A. In one embodiment (not shown), the substrate may move in a countercurrent direction to solution flow through the solution deposition reactor. In certain examples, solution deposition reactor 10A is suitable for use with substrates having a width of at least 10 cm, such as at least 25 cm, at least 50 cm, at least 75 cm, 10-100 cm, or 50-100 cm. Because the substrate is moving relative to the y-axis of the solution deposition reactor, a curvature in the yz-plane may have little or no effect and a material layer having a substantially uniform thickness throughout its length may be deposited. Accordingly, in some embodiments, the top portion has a purposely formed curvature only in the xz-plane.

In one embodiment, (not shown) inlet 20A is a “slot” inlet having a width extending across a width of deposition chamber 10A. A slot inlet has a width that is substantially greater than its length. In such an embodiment, the width of deposition chamber 10A may be substantially constant along the length of the deposition chamber.

In another embodiment, the system shown in FIG. 16 may be used in a semi-continuous manner. Substrate 130A is stationary as solution deposition reactor 10A is lowered into position. A solution comprising one or more reactants flows into solution deposition reactor 10A through inlet 20A. As the solution flows through solution deposition reactor 10A, a material layer is deposited onto the upper surface 131 of the substrate portion positioned beneath the reactor. Solution flow through the reactor is continued for a sufficient period of time to produce a desired material layer thickness. Solution flow then is halted, solution deposition reactor 10A is lifted from substrate 130A, and substrate 130A with the deposited material layer is advanced such that the deposited material layer is distal to solution deposition reactor 10A. Solution deposition reactor 130A is lowered into position on a subsequent portion of substrate 130A, and the process is repeated.

### IV. DEPOSITION MATERIALS

Many different materials can be deposited using the present system, and many devices can be produced using the system and process. The appropriate selection of a deposition material, and hence reactants potentially useful for forming the desired deposition material, will depend on several factors, including primarily the end use requirements of the deposition device constructed. For example, the composition of the material to be deposited can be selected to provide a desired result in a product made using the material. Once the deposition material is identified, the reactants used to form the deposition material can be varied to maximize reaction efficiency, reduce production costs, decrease or minimize toxicity, waste, etc., and combinations thereof. Other variables also can be manipulated, such as: varying the concentration of the material to be deposited; using complexing agents, such as nitrogen-bearing compounds, including ammonia, to facilitate the process; varying the temperature of the reactant solutions and/or the substrate; potentially varying the solvent or suspending liquid to be other than water; and combinations of such variables.

Solely by way of example and without limitation, useful materials that may be formed and deposited by the present device and method for its use include Au, Ag, Cu, Co, Cr, Ge, Ni, Pt, Pd, Rh, Se, Si, Ru, Ag₂S, Ag₂Se, AgO, Ag₂O, Al₂O₃, As₂S₃, BaO, Bi₂S₃, Bi₂Se₃, CdO, CdS, CdSe, CdSnO, CdTe, CdZnS, CeO₂, CoS, CoSe, CoO, CrO₂, CuBiS₂, CuGaSe₂, Cu(In,Ga)Se₂, CuInSe₂, CuInS₂, Cu₂₋ₓS, Cu₂₋ₓSe, Cu₂O, FeO(OH), Fe₂O₃, Fe₃O₄, GaAs, GaN, Ga₂O₃, GaP, Ge, GeO₂, HfO₂, HgS, HgSe, InGaAs, InAs, In₂O₃, InP, In₂S₃, In₂Se₃, La₂O₃, MgO, MnS, MnO₂, MoO₂, MoS₂, MoSe₂, NbO₂, NiS, NiSe, NiO, PbHgS, PbS, PbSe, PbTe, PbO₂, ReO₃, RhO₂, RuO₂, Sb₂S₃, Sb₂Se₃, SiGe, SiO₂, SnS, SnS₂, SnSe, SnO₂, Sb₂S₃, TiO₂, TlS, TlSe, Tl₂O₃, VO₂, WO₂, Y₂O₃, ZnO, ZnS, ZnSe, ZrO₂, etc., and combinations thereof.

As will be apparent to a person of ordinary skill in the art, many of the metals, alloys, semiconductors, etc., that are desirably deposited using the present invention are produced by mixing precursor materials that react to form the desired deposition material. Any effective metal precursor material can be used with the present invention. Solely by way of example, and without limitation, particular examples of metal precursors include halides, acetates, nitrates, sulfates and carbonates. Mixtures of such precursors also can be used.

The reactant sources can be formulated with other materials that facilitate the process. For example, a metal source, such as a zinc (II) source, can be formulated with other materials, such as complexing agents. Many of the useful complexing agents are nitrogen-bearing compounds, including by way of example, and without limitation, ammonia, aliphatic amines, and aliphatic amides, with particular examples including ammonia, triethanolamine, ethanolamine, diethylenetriamine, ethylenediaminetetracetate, hydrazine, nitrilotriacetate and triethylenetriamine. Plural different complexing agents also can be used in combination. The reactant sources also can be formulated in different solvents, such as water and/or organic solvent(s), to form a first fluid mixture and a second fluid mixture. The deposition material, such as zinc oxide, is then formed by combining the first mixture with the second mixture.

The reactants also can include chalcogens, and hence chalcogenide precursors are compounds potentially useful for practicing the present invention. Examples of chalcogenide precursors include, by way of example and without limitation, thiourea, thioacetamide, thiocarbazide, thiosemicarbazide, ethylthiourea, allylthiourea, selenourea, N,N dimethyl selenourea, thiosulfate, selenosulfate, water, peroxide, persulfate, sodium hydroxide, urea, dimethylamineborane, trimethylamineborane, acetamide, hexamethyleneteramine, and combinations of such materials.

### V. THIN FILM STRUCTURES

Embodiments of the disclosed apparatus and process are useful for depositing material layers, such as thin films, on substrates. The film may be an epitaxial nanostructured thin film, a nanoparticle film, a nanocrystalline thin film, an epitaxial thin film comprising embedded nanocrystals, a superlattice thin film, a composition gradient thin film, a composite thin film comprising core-shell nanoparticles, and combinations thereof. Desired particles can be produced by a chemical bath deposition process by controlling the residence time of the mixed reacting solution, by using a combined chemical bath deposition (CBD) and solution-based nanoparticle synthesis process, or by using a nanoparticle solution directly.

In some embodiments, an anti-reflective thin film comprising nanoparticles is applied to a substrate surface. In certain embodiments, a substantially continuous polymer layer is applied to the substrate surface before applying the anti-reflective thin film. In some embodiments, the anti-reflective thing film has a substantially uniform thickness, i.e., the number of nanoparticle layers is substantially the same in any cross-section across the substrate surface. The minimum number of nanoparticle layers is one. In certain embodiments, the anti-reflective thin film also has a substantially uniform concentration of nanoparticles throughout the film, i.e., in any given area of the film, the nanoparticle concentration is substantially the same as in any other area. In some embodiments, the anti-reflective film has a substantially uniform particle density throughout its depth such that the concentration of nanoparticles remains substantially constant throughout the depth of the film. In other words, each nanoparticle layer has substantially the same nanoparticle concentration as any other nanoparticle layer in the film.

Disclosed embodiments of the present invention provide many benefits relative to batch CBD processes. Thin films deposited using embodiments of the present methods and systems are substantially more continuous, and generally have a higher crystallinity, than do thin films deposited by batch processes. Post annealing steps required with batch processes, which are obviated with the present invention, may reduce the porosity of the deposited materials and increase the crystallinity. However, films deposited using the present invention typically are less porous, and often have higher crystallinity, relative to batch processes even without a post deposition annealing step.

Additional disclosure is provided in U.S. Pat. No. 7,507,380, U.S. Pat. No. 7,846,489, U.S. Patent Publication No, 2008/0108122-A1, U.S. Patent Publication No. 2009/0165366-A1, U.S. Patent Publication No. 2009/0245017-A1, U.S. Patent Publication No. 2010/0261304-A1, U.S. Patent Publication No. 2012/0001356-A1, International Publication No. W02010/085764, and International Publication No. WO 2011/156279, which are incorporated herein by reference.

### VI. EXAMPLES

Working examples are provided to illustrate particular features of the disclosed embodiments. The scope of the present invention should not be limited to the features exemplified by these working embodiments.

### Example 1

### Microreactor Design

A microreactor 200 developed for CdS deposition is shown schematically in FIGS. 17-18. The microreactor 200 included a 5-layer stack beginning with a 376×256×6.4 mm thick 6061 T651 aluminum (Al) base plate 210 on which is placed an equally sized 3-mm thick FTO (fluorinated tin oxide)-coated glass substrate 220. Kapton tape was used to mask the glass for a 152×152-mm deposition area. A thin layer of thermal adhesive was applied between the glass substrate 220 and aluminum base plate 210 to aid in heat transfer and temperature control. The borders and geometry of the deposition chamber were then defined by a double stack of 800 μm thick, highly compressible, closed-cell silicone foam 230 (Bisco HT-800).

The upper surface of the deposition chamber was a 3.2-mm thick polycarbonate (PC) sheet 240 with inlet and outlet ports. This was topped by a secondary 12.7-mm top PC plate 250 fitted with complementary inlet and outlet ports. Seals between plates were made using silicone gasket o-rings. The upper surface as defined by sheet 240 was deflected through a combination of point displacements across the width and length of the flow cell. Screws 270 in the secondary 12.7-mm top plate 250 were used to impart point forces on the inner 3.2-mm sheet 240, deflecting it into the deposition chamber. Nine set screws were placed at shown locations in FIG. 11. Initially, five screws were inserted into the top plate 250 arranged in a straight line along the flow axis. Four additional screws were added to provide further control over the deflection profile of sheet 240. An FEA analysis was performed using COSMOS to determine the screw positions and forces to produce the desired deflected surface. Eighteen threaded posts (6.4 mm diameter, 38.1 mm length) were mounted along the perimeter of the aluminum base 210 and topped with nuts and washers to provide compressive sealing force between each layer. In order to restrict the amount of compression in the silicone foam 230, stainless steel shims 260 (800 μm thick) were cut into patterns to reside just outside the silicone foam layer and act as “hard stops” for compression.

As shown in FIG. 11, six thermocouples were inserted through the edge of the flow cell and compressed between the two silicone foam gaskets allowing the tips to protrude into the flow chamber. Additional application of silicone vacuum grease was applied to all layer interfaces to aid in sealing potential leaks once pressurized.

The entire reactor was fixed to a 9″×9″ Wenesco hot plate (1100 W) and positioned vertically. This allowed the buoyancy of any bubbles that were introduced to quickly purge to the outlet. Reactants were maintained at room temperature and pumped through micromixer for quick and efficient mixing before entering a custom built microchannel pre-heater designed to quickly ramp fluid temperature to operating conditions of 83° C.

### Example 2

### Dye Test

Prior to running reactants for CdS deposition, a dye test was run to verify flow uniformity and the integrity of fluidic seals. The flow chamber was filled with deionized water at room temperature at 31 mL/min. The supply stream was then switched to a solution of black dye. Video imagery was used to record and measure the progression of dye as it crossed front, middle, and ending planes of the substrate region.

The CFD (computational fluid dynamics) models of the flow cell were capable of predicting results similar to observations seen in the physical dye tests. The distinctive parabolic flow profile was apparent under parallel plate conditions while a much more uniform profile was seen under deflected plate conditions. Visual and statistical comparison of the baseline parallel plate and the deflected plate flow cells is shown in FIG. 10 and Table 1.

Results showed that the deflected plate method significantly reduced dispersion in the flow front at the front, middle, and back planes of the substrate. CFD results typically underestimated the flow-front dispersion by up to 30%, which showed good agreement with the experimental data. This “under-prediction” may be an artifact of axial diffusion. For both flow cells, the coefficient of variance of the axial position steadily increased as each successive plane was crossed. For the parallel plate flow cell, the standard deviation (as a percentage of substrate size (152 mm)) almost tripled during both CFD modeling and the dye test. For the deflected-plate flow cell, the standard deviation was consistently one third to one half the level of dispersion in the parallel-plate flow cell.

TABLE 1
CFD vs. dye test comparison of moving front uniformity
(% Deviation)

| | Front | Middle | End |
|---|---|---|---|
| Axial Distance → | (57.5 mm) | (143.1 mm) | (228.6 mm) |
| No Deflection (CFD) | 5.16% | 12.33% | 16.97% |
| No Deflection (Dye) | 7.63% | 11.63% | 22.16% |
| Change | 2.47% | −0.70% | 5.19% |
| % Error | 32.37% | −6.02% | 23.43% |
| 200 mm Deflection (CFD) | 3.36% | 3.25% | 6.65% |
| 200 mm Deflection (Dye) | 3.88% | 4.83% | 7.83% |
| Change | 0.52% | 1.58% | 1.18% |
| % Error | 13.44% | 32.74% | 15.11% |

### Example 3

### CdS Deposition

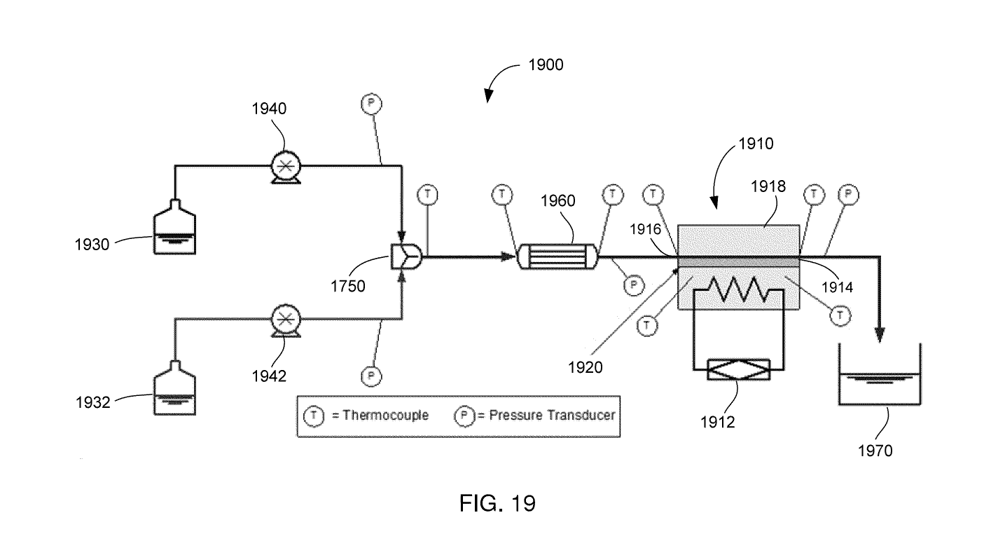

A schematic diagram of a flow cell setup 1800 is shown in FIG. 19 (see also Ramprasad et al., Solar Energy Materials and Solar Cells, 2012, 96:77-85). The system 1800 included the deposition chamber 1810 of Example 1, containing a 152×152-mm soda lime glass substrate 1820 (Pilkington TEC-15) with a fluorine-doped tin oxide (FTO) layer, and an integrated heating system 1812 (a 9″×9″ Wenesco hot plate (1100 W)) to maintain a uniform substrate temperature throughout the residence time. A LabVIEW (National Instruments) program was used for system control and data acquisition.

To deposit a CdS film, the system 1800 was first circulated with room-temperature deionized water and allowed to reach a steady temperature of 83° C. before switching to reagents. In some experimental runs, a gaseous phase appeared within the flow stream. As the deionized water circulating through the system was ramping up to reaction temperature, small pockets of bubbles were observed emerging out of solution at around 65-70° C. Therefore, the flow cell was operated vertically to allow buoyancy to purge the bubbles from the system. Even then, smaller bubbles remained static, leaving pin holes throughout the final film. As a result, a small amount of Triton® X-100 surfactant was added to the recirculating deionized water at 1% by volume. The surfactant greatly increased the mobility of static bubbles, purging them from the system.

Reagents were premixed into two supply vials 1830, 1832 marked A and B with A containing 0.004 M CdCl₂, 0.41 M NH₄OH, and 0.04 NH₄Cl and B containing 0.04 M thiourea. Equal flow rates of 15.5 mL/min. were supplied via positive displacement pumps 1840, 1842 (Acuflow Series III) to a microchannel T-mixer 1850 before a thermally-insulated microchannel heat exchanger 1860 to take the reactants to reacting temperature before entering deposition chamber 1810. Temperature in heat exchanger 1860 was monitored. Induction time after heating was one minute. Temperature in heat exchanger 1860 was monitored. The overall deposition time was 5 minutes, after which all heaters were turned off, and the reagent supply was switched back to deionized water. Excess reagents and byproducts exiting deposition chamber 1810 were collected in a waste container 1870 via flow cell outlet 1814. The system was allowed to flush until pre-heater 1860 temperature was reduced to <40° C., at which time pumps 1840, 1842 where turned off and flow cell chamber 1710 was drained through inlet connector 1816. The top cover 1818 of flow cell 1710 was then removed, and substrate 1820 was rinsed again with deionized water to wash away any non-cohesive particulates.

Film thickness and uniformity were measured by exploiting optical properties of CdS at a wavelength of 500 nm. The general relation of how film thickness relates to percent transmission is as follows:

T=e^{-αt} (Eq. 6)

where T is percent transmission, t is film thickness, and the absorption coefficient (α=143005.31 cm⁻¹) was calculated by averaging the values obtained using Eq. 6. Various CdS films were deposited (Balaji et al., Canadian Journal of Chem. Eng., 2006, 84:715-721), and used for calibration of the measurement technique.

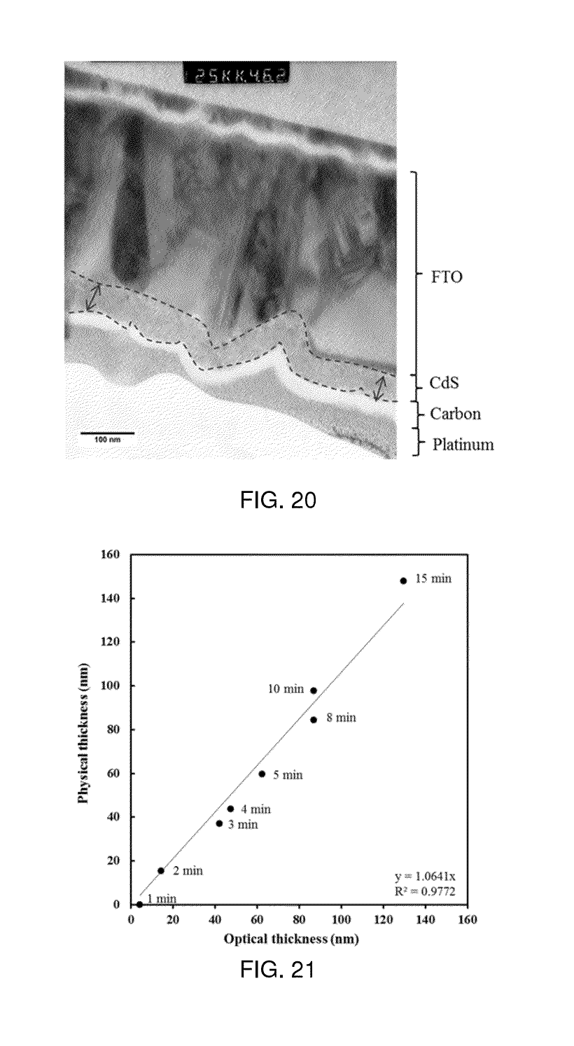

Film thickness (t) was determined by cross-sectioning the films using a focus-ion-beam (FIB) lift-out process and measuring the cross-sectional thickness of the film using transmission electron microscopy (TEM). FIG. 20 shows one of the TEM cross-sections at 125,000× including the entire CdS/FTO structure. The CdS layer is between the FTO film and a carbon film. The carbon and platinum layers on top of the CdS layer were added to prevent surface charge accumulation and to introduce a protection layer during the focused-ion-beam (FIB) milling process. This micrograph shows that the FTO layer on the substrate is rough and the CdS layer on top is conformal.

FIG. 21 shows the calibration curve of optical thickness determined by the 500 nm transmission model (Eq. 6) versus physical thickness measured by the FIB/TEM technique. Each data point represents the optical and physical thickness of a CdS film produced using the specified deposition time.

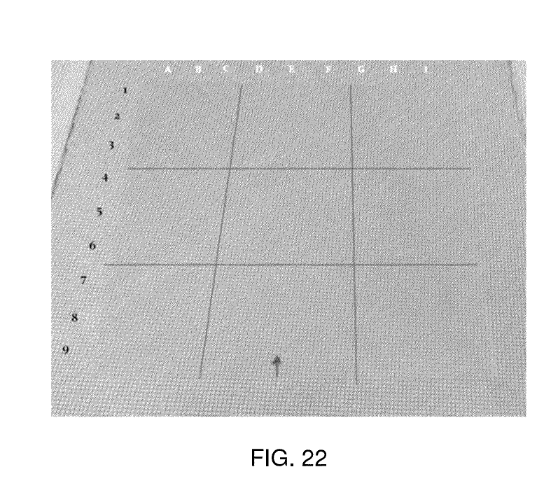

The final films deposited were characterized by first dividing the substrate into regions and labeling the regions by column and row for consistent comparison. FIG. 22 shows an exemplary labeling scheme used for recording data consisting of nine cells each having nine subcells (three rows and three columns). Initially, a total of 45 data points were collected to evaluate the uniformity of the coating consisting of data for the four corner subcells and one center subcell for each cell. The positions were measured for percent transmission using an Ocean Optics UV-Vis spectroscopy system.

For each film, additional analysis was performed to determine what resolution of data points was needed to adequately characterize the film. In general, it was determined that 6×6 data points significantly changed the apparent film uniformity compared to the 45 data points, while 8×8 data points and beyond did not significantly change the apparent film uniformity.

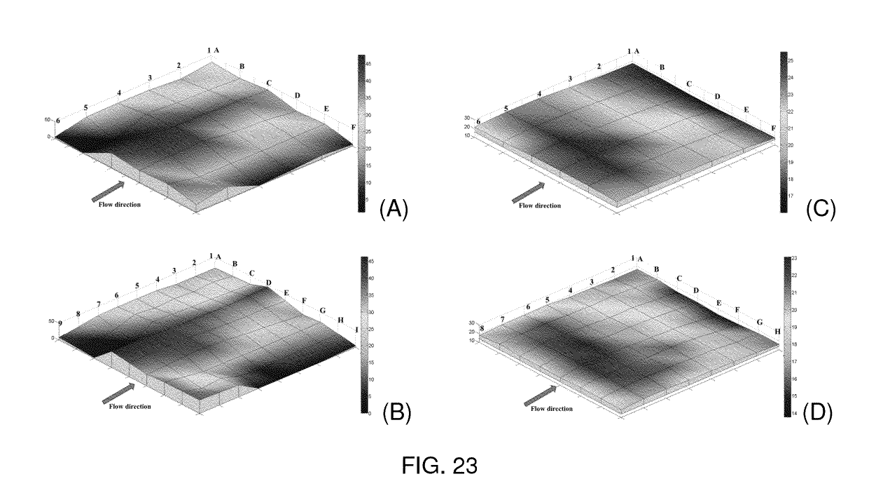

FIGS. 23A-23D show the thickness profiles of CdS films produced using parallel-plate (FIGS. 23A, 23B) and deflected-plate (FIGS. 23C, 23D) flow cells. The arrows indicate flow direction. FIGS. 23A and 23C show data collected using 6×6 data points. FIGS. 23B and 23D show data collected using 45 data points. The results suggest the velocity distribution had a direct impact on the uniformity of the final CdS film. The overall average thickness and standard deviation measured were 25.9 nm±13.5 nm and 21.5 nm±2.6 nm for parallel-plate and deflected-plate conditions, respectively. The overall thickness of the final film in the deflected-plate experiment showed a greater than 5-fold reduction in the variability of the film thickness. For parallel-plate conditions, it was visually apparent that film growth was thicker in the center columns (D through F) and thinner along the outer columns H and I. This follows the intuition that the final film would grow more rapidly in the faster flowing center regions where the convective boundary layer is thinner. This is also a region where reactants are replenished at a much faster rate. This increase in deposition rate may also explain why the film produced in the parallel-plate flow cell is thicker on average than the film produced in the deflected-plate flow cell. Alternatively, differences in average thickness also could be due to the shorter residence time for reactants in the deflected-plate flow cell caused by the higher velocities due to the smaller channel cross-section.

The actual cross-section measurements shown in FIG. 5 indicate an axial flow cell channel height around 400 μm on average. As a rough analysis, assuming that the deflection is triangular, the deflection cuts off about one-quarter of the channel cross-section suggesting a decrease in residence time of 25%. The average thickness of the film produced in the deflected-plate flow cell is about 83% the average thickness of the film produced in the parallel-plate flow cell. Consequently, a 25% change in residence time could produce this difference in film thickness, assuming a linear impact on growth rate with residence time.

Of interest in the deflected plate film is the dip in the film thickness toward the back center of the film which likely caused a considerable amount of the variability in that film. The CFD results for the deflected plate flow cell in FIGS. 6 and 7 show that the flow distribution is significantly worse for the back plane of the plate. This is largely due to the fact that FEA results and the experimental setup were not able to closely match the desired constant velocity cross-sections adjacent to this region. This is demonstrated in FIG. 5, which shows a comparison of the CFD and measured channel cross-sections within the deflected-plate flow cell. It is likely that discrepancies in back-row dimensions between the experimental and the ideal constant velocity flow cell designs led to higher (double) flow profile deviations for the back row of the flow cell as shown in Table 1. The suppression of flow in the back center of the flow cell led to a thinner film in that region. This suggests the importance of maintaining constant velocity through the deposition region of the flow cell. This issue could be ameliorated through the use of a different technique to implement the deflected cross-section. One such technique could be to machine the deflected profile into the upper plate rather than to use plate mechanics.

In FIGS. 23A-23D, the back row of measurements all show lower thicknesses. This suggests that the deposition rate is slower toward the back of the flow cell. Possible reasons for this could be a higher concentration of byproducts impeding mass transfer of reactants, or simply depletion of reactants. Of further interest toward the back of the substrate is the fact that the edges of the film are thinning before the center axis of the film. The flow path along the side of the flow cell is longer than the flow path down the axis of the flow cell. This could be further evidence for the depletion of reactants.

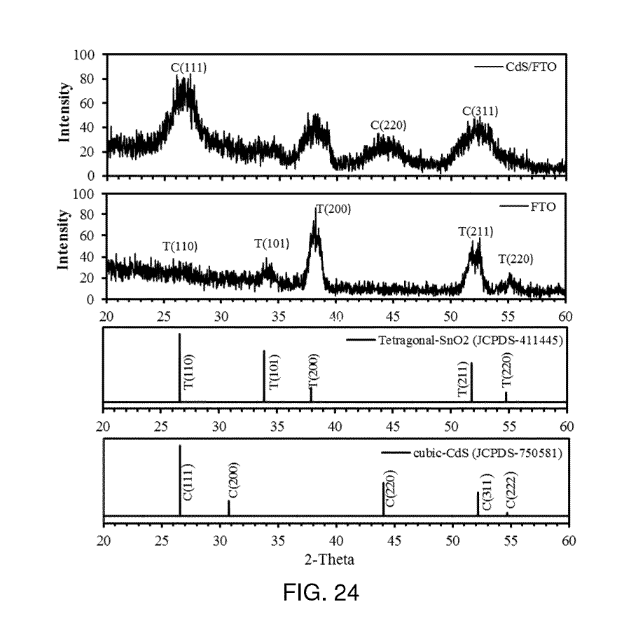

FIG. 24 shows grazing-incidence (0.5°) X-ray diffractograms (Bruker D8 Discover, CuKα=1.54056 Å) of the bare FTO substrate and the CdS film deposited by the deflected-plate flow cell. All peaks from the bare FTO layer index match exactly to tetragonal SnO₂ (JCPDS-411445). The CdS film shows peaks at 26.45°, 43.78°, and 51.96°, which match well with C(111), C(220), and C(311) of cubic CdS (JCPDS-750581).

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A deposition device, comprising:
at least one wall defining a top portion and two side portions of a deposition chamber having a width in the x-axis, a length in the y-axis, and a height in the z-axis, the deposition chamber comprising a first region and a second region, the at least one wall having a purposely formed curvature in the xz-plane or both the xz- and yz-planes, wherein the purposely formed curvature defines the deposition chamber height, thereby altering fluid flow characteristics in the deposition chamber; and
an inlet in fluid communication with the first region.

2. The deposition device of claim 1 where the at least one wall further has a second curvature in the xy-plane defining the deposition chamber width.

3. The deposition device of claim 1 where the deposition chamber further comprises a third region, the deposition device further comprising an outlet in fluid communication with the third region.

4. The deposition device of claim 1 where the purposely formed curvature is selected to provide a substantially constant flow velocity, a substantially constant residence time through a length of the deposition chamber, or a combination thereof, for portions of a fluid flowing across a cross-sectional width of the second region.

5. The deposition device of claim 1 where the purposely formed curvature in the xz-plane produces a minimum height along a central lengthwise axis of the deposition chamber.

6. The deposition device of claim 1 where the purposely formed curvature in the yz-plane varies along a central lengthwise axis of the deposition chamber such that the deposition chamber has a height at a distal portion of the deposition chamber that is greater than a height adjacent to the inlet.

7. The deposition device of claim 1 where the purposely formed curvature is variable.

8. The deposition device of claim 1 where portions of a fluid flowing through the deposition chamber have a residence time within the deposition chamber that varies by ≦20% across a cross-sectional width of the deposition chamber.

9. The deposition device of claim 1, where the moving front has a position, as measured from the inlet, that has a standard deviation of ≦20% across a cross-sectional width of the deposition chamber as the fluid flows through the second region.

10. The deposition device of claim 1 where each of the two side portions extends outwardly from a central lengthwise axis of the deposition chamber for a first distance L1 to form the first region, and extends over a second distance L2 to form the second region.

11. The deposition device of claim 10 where the deposition chamber includes the third region, and each of the two side portions further extends inwardly over a third distance L3 to form the third region.

12. The deposition device of claim 1 where the top portion is pre-formed to have the purposely formed curvature.

13. The deposition device of claim 1 where the top portion further comprises a flexible component defining an upper surface of the deposition chamber, a rigid component positioned above the flexible component, and deflecting means for deflecting the flexible component to produce the purposely formed curvature.

14. The deposition device of claim 13 where the deflecting means comprises one or more adjustable set screws extending downwardly through the rigid component such that a lower end of at least one set screw contacts an upper surface of the flexible component and applies a downward force to the flexible component, thereby producing the purposely formed curvature.

15. The deposition device of claim 1 where the deposition chamber has a maximum width of 50 mm to 1,500 mm, a minimum height of at least 0.1 mm, and a maximum height less than or equal to 100 mm.

16. The deposition device of claim 1, further comprising at least one unit operation device. wherein the unit operation device is a mixer in fluid communication with the inlet, a substrate heater, a deposition chamber heater, or a pre-heater positioned upstream of the inlet, or any combination thereof.

17. The deposition device of claim 1, further comprising a doctor blade substantially parallel to and adjacent to a distal end of the second region.

18. The deposition device of claim 1, further comprising a substrate.

19. The deposition device of claim 18 where the substrate is capable of movement relative to the deposition chamber.

20. The deposition device of claim 18 where the at least one wall further defines a bottom portion of the deposition chamber and the substrate is positioned on the bottom portion.

21. The deposition device of claim 18 where the substrate defines a bottom portion of the deposition chamber.

22. The deposition device of claim 18 where the purposely formed curvature enables a solution flowing through the deposition chamber to deposit a material layer having a substantially uniform thickness onto the substrate.

23. A system, comprising at least two devices according to claim 1, either in series or in parallel, for depositing at least one material layer onto a substrate.

24. A method for depositing a material layer, comprising:
providing a deposition device according to claim 1 and a substrate; and
flowing a solution comprising one or more reactants into the inlet and through the deposition chamber, thereby depositing a material layer onto the substrate as the solution flows through the deposition chamber.

25. The method of claim 24 where the material layer has an average thickness ≦50 nm.

26. The method of claim 24 where the deposition device further comprises a source of a first reactant in fluid communication with the deposition chamber and a source of a second reactant in fluid communication with the deposition chamber.

27. The method of claim 24 where the substrate is a movable substrate, the method further comprising:
positioning the deposition device onto the substrate before flowing the solution through the deposition chamber, wherein the substrate forms a bottom portion of the deposition chamber; and
moving the substrate relative to the deposition device to form the material layer on the substrate.

28. The method of claim 24, wherein the substrate has at least one of a width or a length greater than a width or a length of the deposition chamber, the method further comprising:
positioning the deposition device onto a first portion of the substrate before flowing the solution through the deposition chamber, wherein the substrate forms a bottom portion of the deposition chamber;
flowing the solution through the deposition chamber for a period of time to form a material layer on the first portion of the substrate;
removing the deposition device from the first portion of the substrate;
positioning the deposition device onto a subsequent portion of the substrate; and
flowing the solution through the deposition chamber for a period of time to form a material layer on the subsequent portion of the substrate.

29. The method of claim 24 where the substrate has a length greater than a length of the deposition chamber, the method further comprising:
positioning the deposition device onto a first portion of a substrate before flowing the solution through the deposition chamber, wherein the substrate forms a bottom portion of the deposition chamber;
flowing the solution through the deposition chamber to form a material layer on the substrate; and
moving the substrate substantially continuously in a direction concurrent with the solution flow.

30. The method of claim 29 where a flow rate of the solution through the deposition chamber is greater than a rate of substrate movement.
